(19) United States
(12) Patent Application Publication
(10) Pub. No.: US 2017/0111531 A1
(43) Pub. Date: Apr. 20, 2017

(54) SCAN PROCESSING SYSTEM, INFORMATION PROCESSING SYSTEM, AND COOPERATIVE PROCESSING METHOD

(71) Applicants: Isamu MITSUKE, Kanagawa (JP); Kiyohiro HYO, Tokyo (JP); Hiroki ASAKIMORI, Tokyo (JP)

(72) Inventors: Isamu MITSUKE, Kanagawa (JP); Kiyohiro HYO, Tokyo (JP); Hiroki ASAKIMORI, Tokyo (JP)

(73) Assignee: Ricoh Company, Ltd., Tokyo (JP)

(21) Appl. No.: 15/291,368

(22) Filed: Oct. 12, 2016

(30) Foreign Application Priority Data
Oct. 14, 2015 (JP) 2015-202939
Jan. 26, 2016 (JP) 2016-012742
Jul. 11, 2016 (JP) 2016-136834

(51) Int. Cl. H04N 1/00; H04N 1/44; H04N 1/32; H04L 29/06

(52) U.S. Cl. CPC H04N 1/00798; H04L 63/083; H04N 1/00344; H04N 1/4433; H04N 1/32122; H04N 1/32374; H04N 2201/0094; H04N 2201/0039

(57) ABSTRACT

A scan processing system is provided that includes a processor configured to execute a program stored in a memory to implement processes of accepting, from a terminal apparatus, a registration of a scan setting for a scan process to be executed by the input/output device; issuing code information for the scan setting and sending the issued code information to the terminal apparatus in response to the registration of the scan setting; storing the scan setting that has been accepted from the terminal apparatus in association with the code information that has been sent to the terminal apparatus in response to the registration; and upon receiving the code information from the input/output device, sending the scan setting that is stored in association with the code information to the input/output device and controlling the input/output device to execute the scan process based on the scan setting.

### CROSS-REFERENCE TO RELATED APPLICATIONS

The present application claims priority under 35 U.S.C. §119 to Japanese Patent Application No. 2015-202939 filed on Oct. 14, 2015, Japanese Patent Application No. 2016-012742 filed on Jan. 26, 2016, and Japanese Patent Application No. 2016-136834 filed on Jul. 11, 2016, the entire contents of which are incorporated herein by reference.

### BACKGROUND OF THE INVENTION

1. Field of the Invention

The present invention relates to a service providing system, an information processing apparatus, an information processing system, and a cooperative processing method.

2. Description of the Related Art

In recent years, with the advancement of information technology such as cloud computing, a wide variety of services are provided over a network. Techniques are known for enabling a document input/output device such as an MFP to cooperate with a cloud service to scan a document and implement work flows in various patterns.

For example, a system is known that uses a service provided by an image processing apparatus (image processing function) in cooperation with a service provided by a cloud system (see e.g., Japanese Unexamined Patent Publication No. 2014-27492).

### SUMMARY OF THE INVENTION

According to one embodiment of the present invention, a scan processing system is provided for controlling an input/output device including a scanner to execute a scan process. The scan processing system includes a memory storing a program and a processor configured to execute the program to implement processes of accepting, from a terminal apparatus, a registration of a scan setting for the scan process to be executed by the input/output device; issuing code information for the scan setting and sending the issued code information to the terminal apparatus in response to the registration of the scan setting; storing the scan setting that has been accepted from the terminal apparatus in association with the code information that has been sent to the terminal apparatus in response to the registration; and upon receiving the code information from the input/output device, sending the scan setting that is stored in association with the code information to the input/output device and controlling the input/output device to execute the scan process based on the scan setting.

### BRIEF DESCRIPTION OF THE DRAWINGS

FIG. 1 is a block diagram illustrating an example configuration of an information processing system according to a first embodiment of the present invention;

FIG. 2 is a block diagram illustrating an example hardware configuration of a computer according to the first embodiment;

FIG. 3 is a block diagram illustrating an example hardware configuration of an image forming apparatus according to the first embodiment;

FIG. 4 is a block diagram illustrating an example functional configuration of the information processing system according to the first embodiment;

FIG. 5 is a sequence chart illustrating an example scan delivery process that is executed using a PIN code;

FIG. 6 is a sequence chart illustrating the example scan delivery process that is executed using a PIN code continued from FIG. 5;

FIG. 7 is a diagram illustrating a relationship between various parameters;

FIG. 8 illustrates an example configuration of flow parameters;

FIG. 9 illustrates an example configuration of job parameters;

FIG. 10 illustrates an example configuration of command parameters;

FIG. 11 illustrates an example configuration of file parameters;

FIG. 12 is a table indicating an association between command parameters and a PIN code;

FIG. 13 is diagram illustrating an example screen transition of an external application upon registering an application;

FIG. 14 is a diagram illustrating an example screen transition of the external application upon registering a scan job;

FIG. 15 is a diagram illustrating an example screen transition of a browser upon executing a scan job;

FIG. 16 is a sequence chart illustrating an example scan delivery process that is executed by logging in according to a second embodiment of the present invention;

FIG. 17 is a diagram illustrating another example screen transition of the browser upon executing a scan job;

FIG. 18 is a block diagram illustrating an example functional configuration of the information processing system according to a third embodiment of the present invention;

FIG. 19 is a sequence chart illustrating an example scan registration process that is executed by signing in according to the third embodiment;

FIGS. 20A and 20B are diagrams illustrating examples of a command registration request and a command registration response;

FIG. 21 is a sequence chart illustrating an example of a scan execution process;

FIG. 22 is a sequence chart illustrating an example of a command status/scan result acquisition process;

FIGS. 23A and 23B are diagrams illustrating examples of a command status acquisition request and a command status acquisition response;

FIGS. 24A and 24B are diagrams illustrating examples of a scan file acquisition request and a scan file acquisition response;

FIG. 25 is a block diagram illustrating an example configuration of the information processing system according to a fourth embodiment of the present invention;

FIG. 26 is a block diagram illustrating an example functional configuration of the information processing system according to the fourth embodiment;

FIG. 27 illustrates an example configuration of a scan file;

FIG. 28 is a table illustrating an example configuration of classification information; and

FIG. 29 is a flowchart illustrating an example process for determining a storage destination and a storage method for the scan file.

### DESCRIPTION OF THE EMBODIMENTS

An aspect of the present invention relates to providing a service providing system that can simplify operations to be performed at the input/output device for executing a scan job.

In the following, embodiments of the present invention are described with reference to the accompanying drawings.

### First Embodiment

<System Configuration>

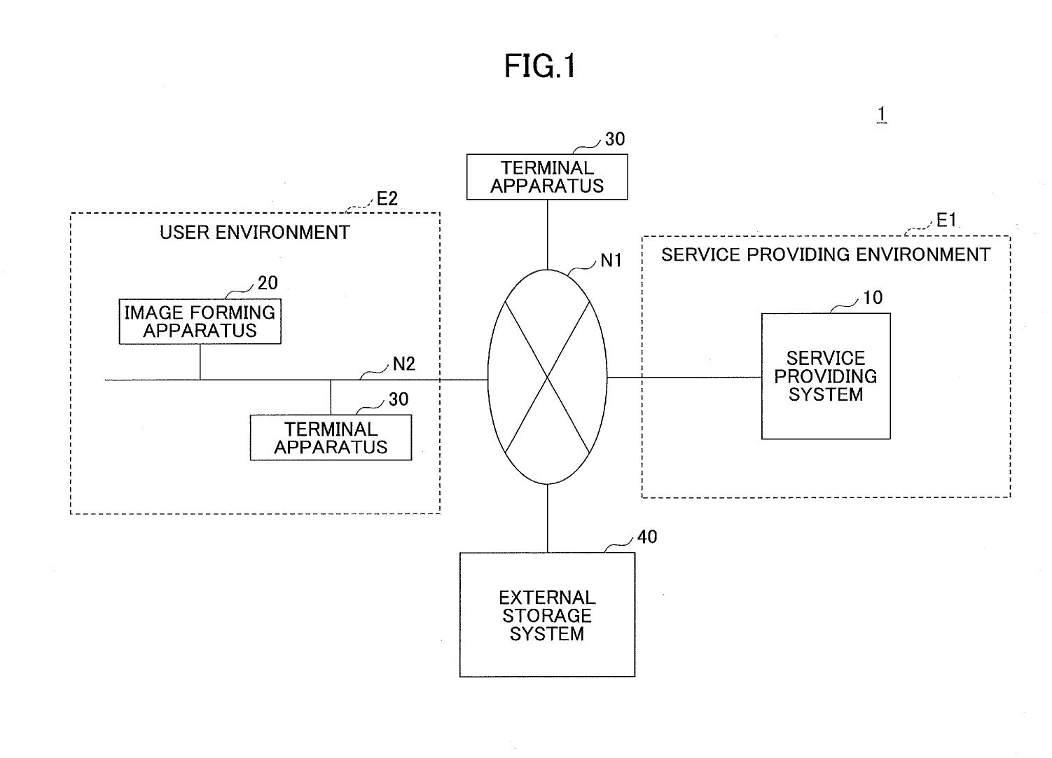

FIG. 1 is a block diagram illustrating an example configuration of an information processing system 1 according to a first embodiment of the present invention. In FIG. 1, the information processing system 1 includes a service delivery environment E1, a user environment E2, and an external storage system 40 that are communicably connected via a wide area network N1 such as the Internet.

The service delivery environment E1 is a system environment that provides a service, such as a cloud service, via the network N1. Note that in the present embodiment, a cloud service is described as an example of a service provided by the service delivery environment E1. However, in other embodiments, the service provided by the service delivery environment E1 may be a service provided by an ASP (Application Service Provider), a web service, or some other type of service.

The service providing environment E1 includes a service providing system 10 that is implemented by at least one information processing apparatus. The service providing system 10 provides a predetermined service via the network N1. For example, the service providing system 10 may provide a service for storing an electronic file that is generated by scanning a document at an image forming apparatus 20 of the user environment E2 in an external storage system 40 (scan delivery service). In the information processing system 1 according to the first embodiment, the service providing system 10 is described as a system that provides such a scan delivery service.

Note that in some embodiments, all or a part of the service providing system 10 may be provided within the user environment E2, for example. That is, all or a part of the information processing apparatus configuring the service providing system 10 may be included in the user environment E2.

The user environment E2 is a system environment of a user, such as a corporation, that uses the image forming apparatus 20, for example. The user environment E2 includes the image forming apparatus 20 and a terminal apparatus 30 that are connected to each other via a network N2 such as a LAN, for example. The image forming apparatus 20 is an example of an input/output device including a scanner (scan function) according to an embodiment of the present invention. The image forming apparatus 20 may be an electronic device, such as a multifunction peripheral (MFP), having other functions, such as a printing function, a copying function, and/or a facsimile (FAX) communication function, in addition to a scan function, for example. The terminal apparatus 30 according to the first embodiment is an apparatus that can be operated by a user, such as a desktop PC (personal computer), a notebook PC, a smartphone, a mobile phone, or a tablet PC having a general OS is installed therein, for example.

The external storage system 40 is a computer system for providing a type of cloud service referred to as storage service (or online storage) via the network N1. A storage service refers to a service of renting out a storage area of the external storage system 40 to a user.

The scan delivery service according to the first embodiment involves storing (uploading) an electronic file obtained as a result of scanning a document in the storage area rented out by the external storage system 40. The external storage system 40 may be a system implemented by a plurality of information processing apparatuses, for example.

Note that the configuration of the information processing system 1 illustrated in FIG. 1 is merely one example, and the information processing system 1 may have other various configurations. For example, more than one image forming apparatuses 20 may be included in the information processing system 1. Also, the terminal apparatus 30 may be connected to the network N1, for example.

<Hardware Configuration>

<<Computer>>

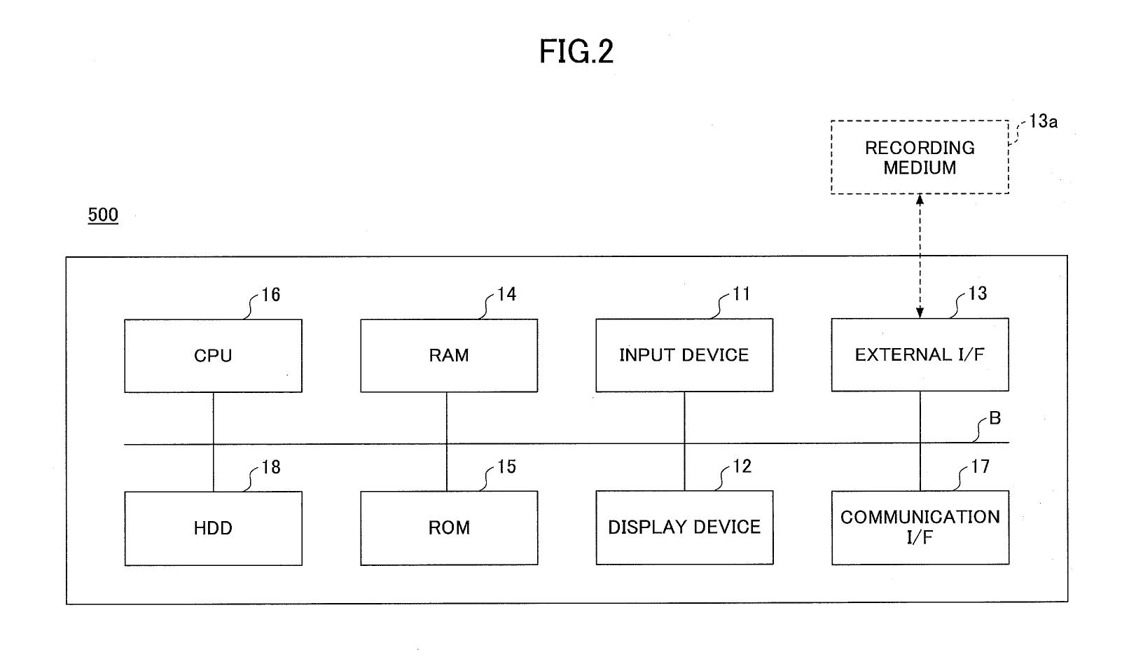

The one or more information processing apparatuses configuring the service providing system 10 and the external storage system 40 of FIG. 1 may be implemented by a computer having a hardware configuration as illustrated in FIG. 2, for example. Also, the terminal apparatus 30 of FIG. 1 may similarly be implemented by a computer having the hardware configuration as illustrated in FIG. 2, for example.

FIG. 2 is a block diagram illustrating an example hardware configuration of a computer 500 according to the first embodiment. In FIG. 2, the computer 500 includes an input device 11, a display device 12, an external I/F (interface) 13, a RAM (Random Access Memory) 14, a ROM (Read-Only Memory) 15, a CPU (Central Processing Unit) 16, a communication I/F 17, and an HDD (Hard Disk Drive) 18 that are connected to each other by a bus B.

The input device 11 may include a keyboard, a mouse, and/or a touch panel, for example, and is used by a user to input an operation signal. The display device 12 may include a display for displaying a processing result of the computer 500, for example. Note that in some embodiments, the input device 11 and the display device 12 may be connected to the computer 500 when necessary, for example.

The communication I/F 17 is an interface for connecting the computer 500 to the network N1. In this way, the computer 500 can perform data communication via the communication I/F 17. The HDD 18 is an example of a nonvolatile storage device that stores programs and data. The programs and data stored in the HDD 18 may include an OS, which is basic software for controlling the computer 500, and various types of application software that provide various functions on the OS, for example.

Note that in some embodiments, the computer 500 may include a drive device that uses a flash memory, such as a solid state drive (SSD), as a storage medium instead of the HDD 18, for example. The programs and data stored in the HDD 18 may be managed by a predetermined file system and/or a database DB, for example.

The external I/F 13 is an interface with an external device. The external device may be a recording medium 13a, for example. In this way, the computer 500 can read/write data from/in the recording medium 13a via the external I/F 13. The recording medium 13a may be a flexible disk, a CD, a DVD, an SD memory card, or a USB memory, for example.

The ROM 15 is a non-volatile semiconductor memory (storage device) that can retain programs and data even when the power is turned off. The ROM 15 may store programs and data, such as BIOS (Basic Input/Output System) that is executed when the computer 500 is started, OS settings, and network settings, for example. The RAM 14 is a volatile semiconductor memory (storage device) for temporarily storing programs and data.

The CPU 16 is a processor that implements controls and functions of the computer 500 by loading programs and data stored in a storage device, such as the ROM 15 or the HDD 18, in the RAM 14 and executing processes based on the loaded programs and data, for example.

Note that various processes of the present embodiment as described below may be executed using the above-described hardware configuration of the computer 500 that constitutes the one or more information processing apparatuses configuring the service providing system 10 and the external storage system 40 according to the present embodiment. Further, the terminal apparatus 30 may also implement the hardware configuration of the computer 500 to implement various processes as described below.

<<Image Forming Apparatus>>

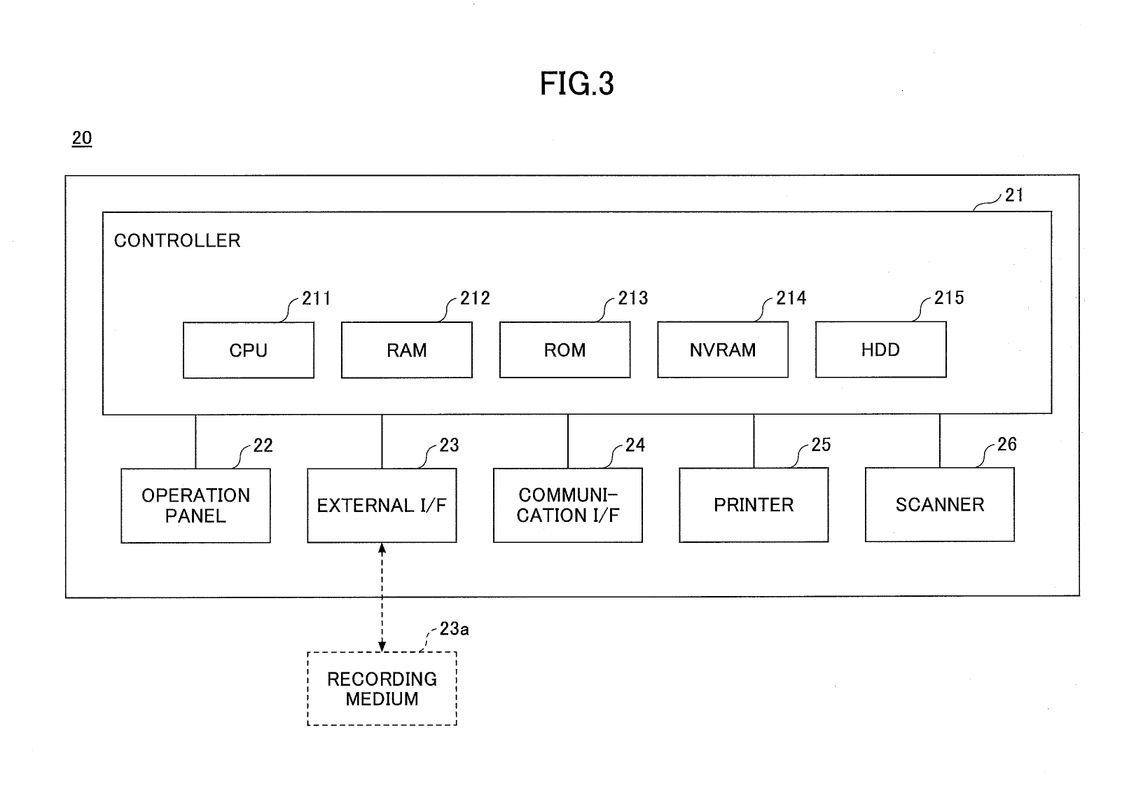

The image forming apparatus 20 of FIG. 1 may have a hardware configuration as illustrated in FIG. 3, for example. FIG. 3 illustrates an example hardware configuration of the image forming apparatus 20 according to the first embodiment. In FIG. 3, the image forming apparatus 20 includes a controller 21, an operation panel 22, an external I/F 23, a communication I/F 24, a printer 25, and a scanner 26.

The controller 21 includes a CPU 211, a RAM 212, a ROM 213, an NVRAM 214, and an HDD 215. The ROM 213 stores various programs and data. The RAM 212 temporarily stores programs and data. The NVRAM 214 stores setting information, for example. The HDD 215 stores various programs and data.

The CPU 211 is a processor that implements controls and functions of the image forming apparatus 20 by loading programs, data, and/or setting information stored in the ROM 213, the NVRAM 214, and/or the HDD 215 in the RAM 212, and executing processes based on the loaded programs, data, and/or setting information, for example.

The operation panel 22 includes an input unit for accepting an input from a user, and a display unit for displaying information. The external I/F 23 is an interface with an external device. The external device may be a recording medium 23a, for example. In this way, the image forming apparatus 20 may read/write data from/in the recording medium 23a via the external I/F 23. Note that the recording medium 23a may be an IC card, a flexible disk, a CD, a DVD, an SD memory card, or a USB memory, for example.

The communication I/F 24 is an interface for connecting the image forming apparatus 20 to the network N2. In this way, the image forming apparatus 20 can perform data communication via the communication I/F 24.

The printer 25 is a printing device for printing print data on a printing medium. Note that the printing medium may be paper, but is not limited thereto, and may be coated paper, cardboard, an OHP, a plastic film, a prepreg, or a copper foil, for example. The scanner 26 is a scanning device that scans a document to obtain image data (electronic data) of the document and generate an image file (electronic file).

Using the hardware configuration as described above, the image forming apparatus 20 according to the first embodiment may implement various processes as described below.

<Software Configuration>

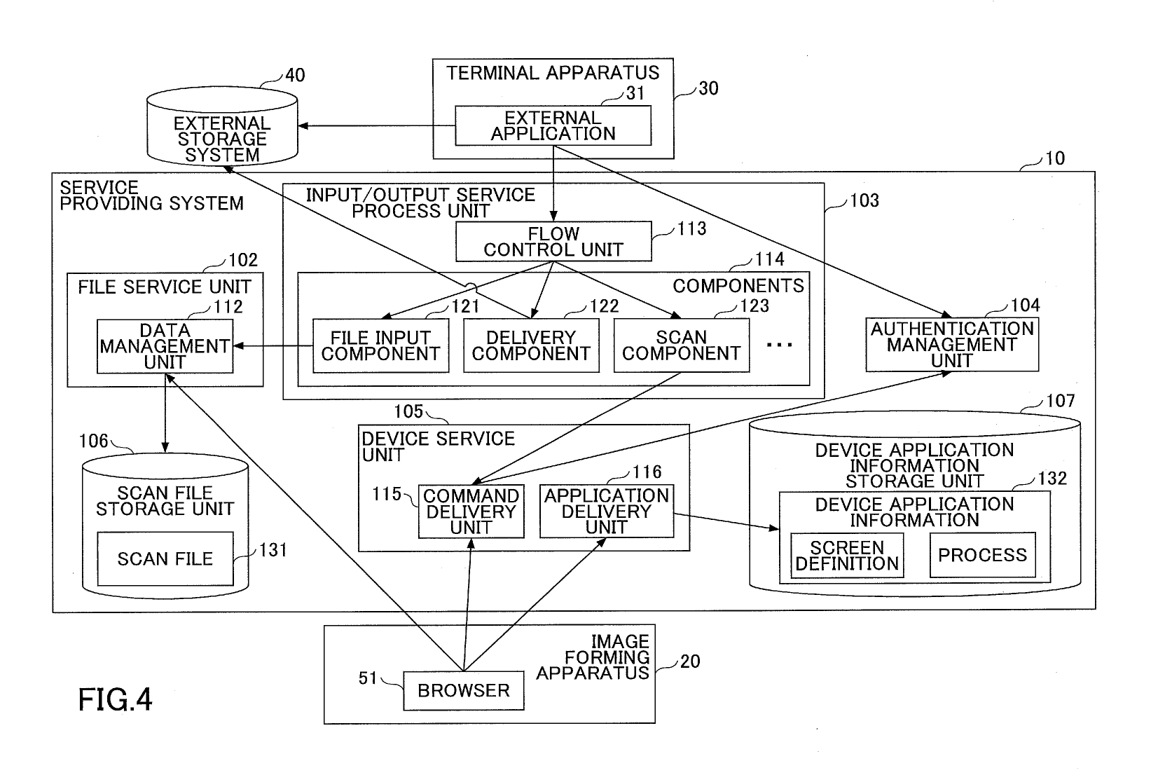

The information processing system 1 according to the first embodiment may have a functional configuration as illustrated in FIG. 4, for example. FIG. 4 is a block diagram illustrating an example functional configuration of the information processing system 1 according to the first embodiment.

In FIG. 4, a browser 51 is installed in the image forming apparatus 20. In this way, the user of the image forming apparatus 20 may be able to use a service provided by the service providing system 10 via the browser 51. According to an aspect of the first embodiment, the image forming apparatus 20 only needs to have the browser 51 installed therein. By installing the browser 51, the image forming apparatus 20 can access the service providing system 10 and display web content acquired from the service providing system 10 via the browser 51.

The service providing system 10 is a system environment that provides a service, such as a cloud service, via the network N1. The service providing system 10 is an example of a scan processing system including a scanner according to the present invention. The service providing system 10 includes a file service unit 102, an input/output service process unit 103, an authentication management unit 104, a device service unit 105, a scan file storage unit 106, and a device application information storage unit 107.

Note that the file service unit 102, the input/output service process unit 103, the authentication management unit 104, and the device service unit 105 may be implemented by the CPU 16 executing a relevant program that is installed in the service providing system 10, for example. The scan file storage unit 106 and the device application information storage unit 107 may be implemented by a storage device that is connected to the service providing system 10 via the network N1, for example.

The file service unit 102 includes a data management unit 112. The data management unit 112 may implement various functions, such as managing scan files 131, issuing file tokens, and performing verification, for example. The input/output service process unit 103 includes a flow control unit 113 and a group of components 114.

For example, a series of processes describing a flow, such as executing a scan process using a PIN code and storing a resulting scan file in the external storage system 40, may be registered in the flow control unit 113 by an external application 31. The flow control unit 113 creates a job based on flow parameters and calls relevant components included in the group of components 114.

Note that a component refers to a module for executing a process, and may be defined by a class or a function, for example. In FIG. 4, the group of components 114 includes a file input component 121, a delivery component 122, and a scan component 123. The scan component 123 issues a scan command. The file input component 121 acquires a file (image data) that has been saved by the scan command and passes the acquired file to a next component. The delivery component 122 stores a file in the external storage system 40. The authentication management unit 104 issues code information, such as an application token, a PIN code, a temporary code, and/or a file token, and performs verification of such code information.

The device service unit 105 includes a command delivery unit 115 and an application delivery unit 116. The command delivery unit 115 processes a scan command that has been issued by the scan component 123. If a scan process is configured to be executed using a PIN code, the command delivery unit 115 requests the authentication management unit 104 to issue a PIN code and acquires the PIN code from the authentication management unit 104.

The application delivery unit 116 delivers web content of device application information to be implemented/displayed on the browser 51 of the image forming apparatus 20. For example, the application delivery unit 116 may deliver a screen based on a screen definition included in device application information 132 in response to a request from the browser 51. In this way, the browser 51 of the image forming apparatus 20 may be able to display a screen for using a service provided by the service providing system 10.

The scan file storage unit 106 stores one or more scan files 131. The device application information storage unit 107 stores the device application information 132. The device application information 132 includes a screen definition describing the layout of a screen using HTML or CSS, for example, and a description of a process for implementing a service.

The terminal apparatus 30 has the external application 31 installed therein. The external application 31 uses an API of the input/output service process unit 103 to provide a cloud service or a mobile application to the user, for example. The external storage system 40 is a system environment that rents out a storage area to a user such that the user can store electronic data such as a scan file in the storage area.

<Process Details>

In the following, processes executed by the information processing system 1 according to the first embodiment are described.

<<Scan Delivery Service>>

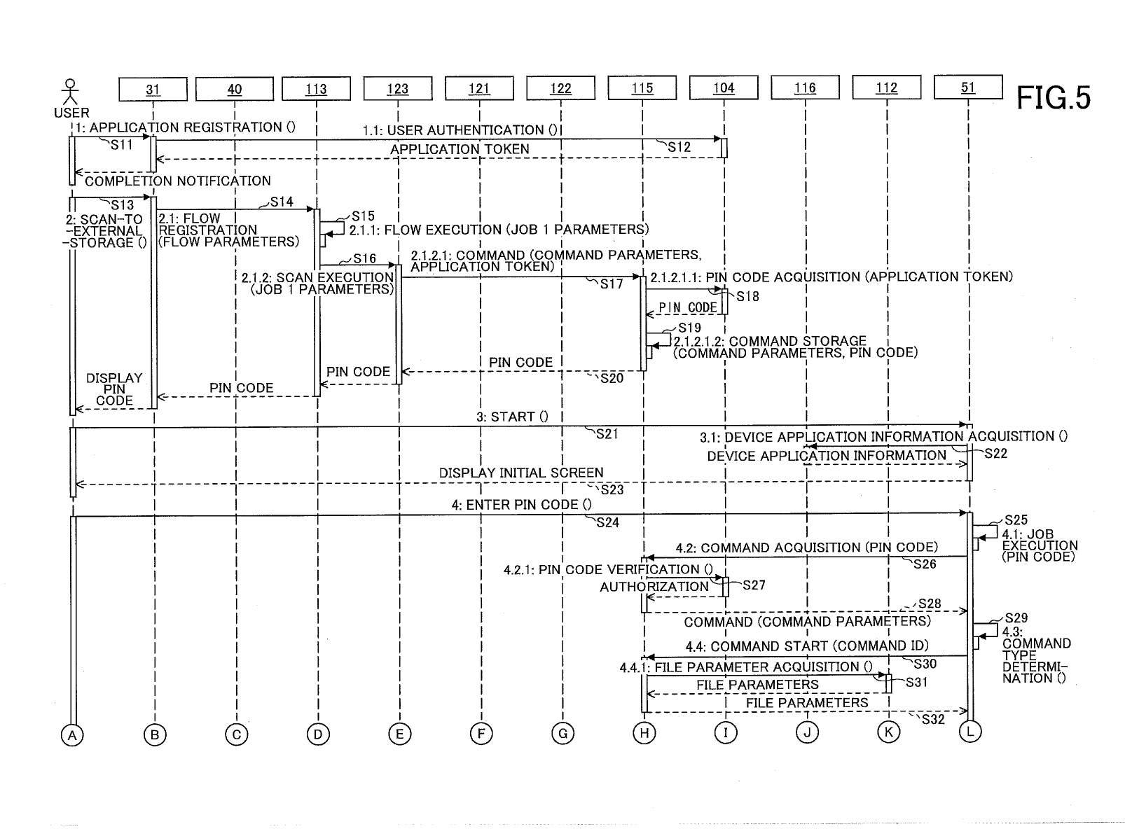

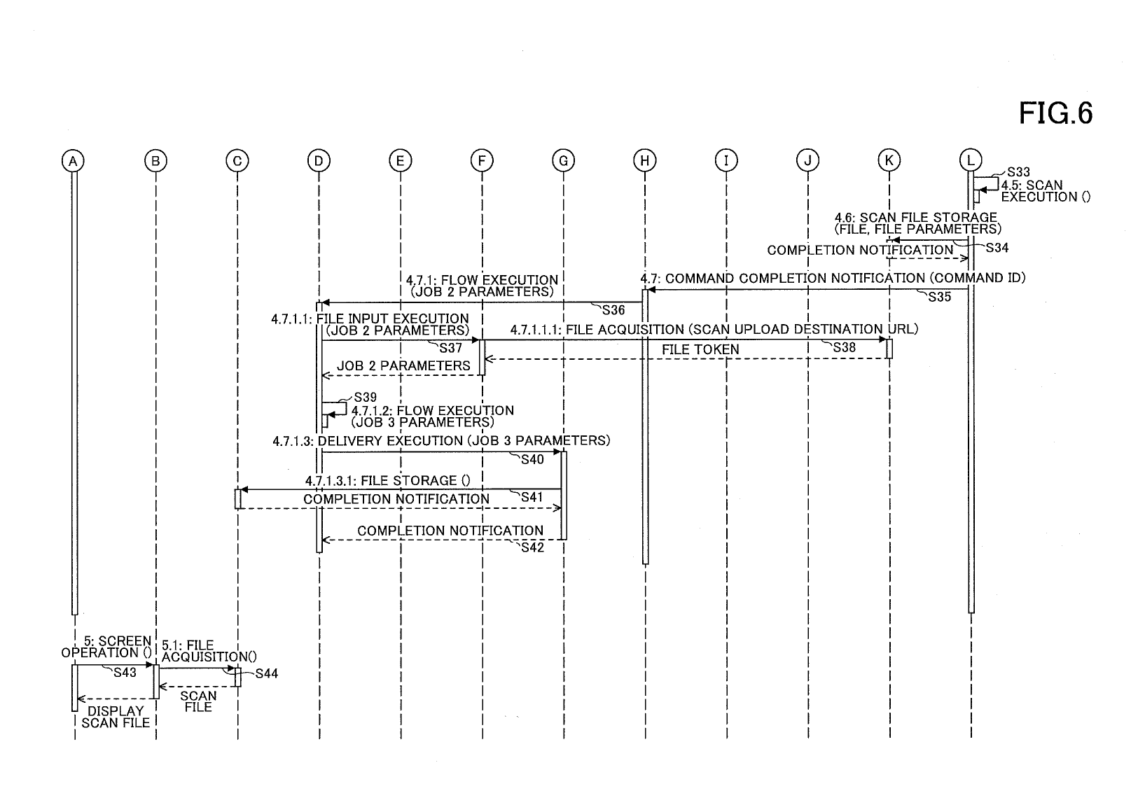

FIGS. 5 and 6 are sequence charts illustrating an example scan delivery process that is executed using a PIN code. FIGS. 5 and 6 illustrate processes for storing a scan file that has been obtained by scanning a document in the external storage system 40, using a PIN code.

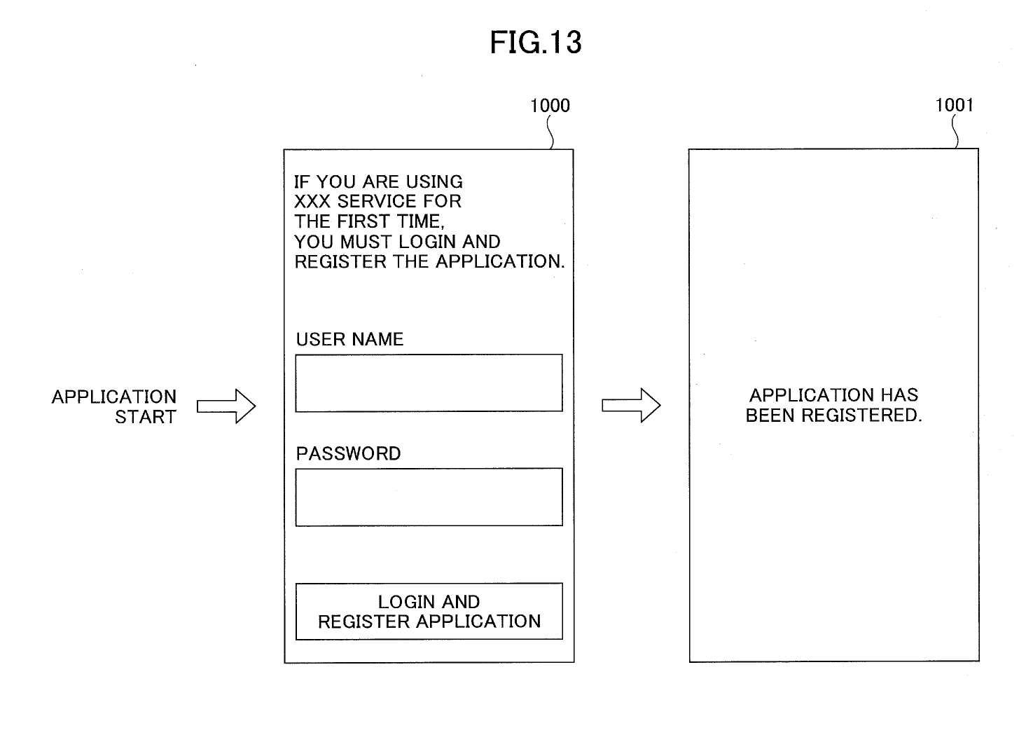

In step S11, the user of the terminal apparatus 30 makes a request to register an application on the external application 31. FIG. 13 illustrates an example screen transition of the external application 30 when an application is being registered. In the example of FIG. 13, the user enters pre-registered user authentication information, such as a user name and a password, in an application registration screen 1000 and presses a “login and register application” button.

Then, in step S12, the external application 31 requests the authentication management unit 104 of the service providing system 10 to perform user authentication. If the user authentication is successful, the authentication management unit 104 issues an application token and returns the application token to the external application 31. In turn, the external application 31 displays an application registration completion screen 1001 to notify the user that registration of the application has been completed. Note that registration of the application is required when the application is being used for the first time.

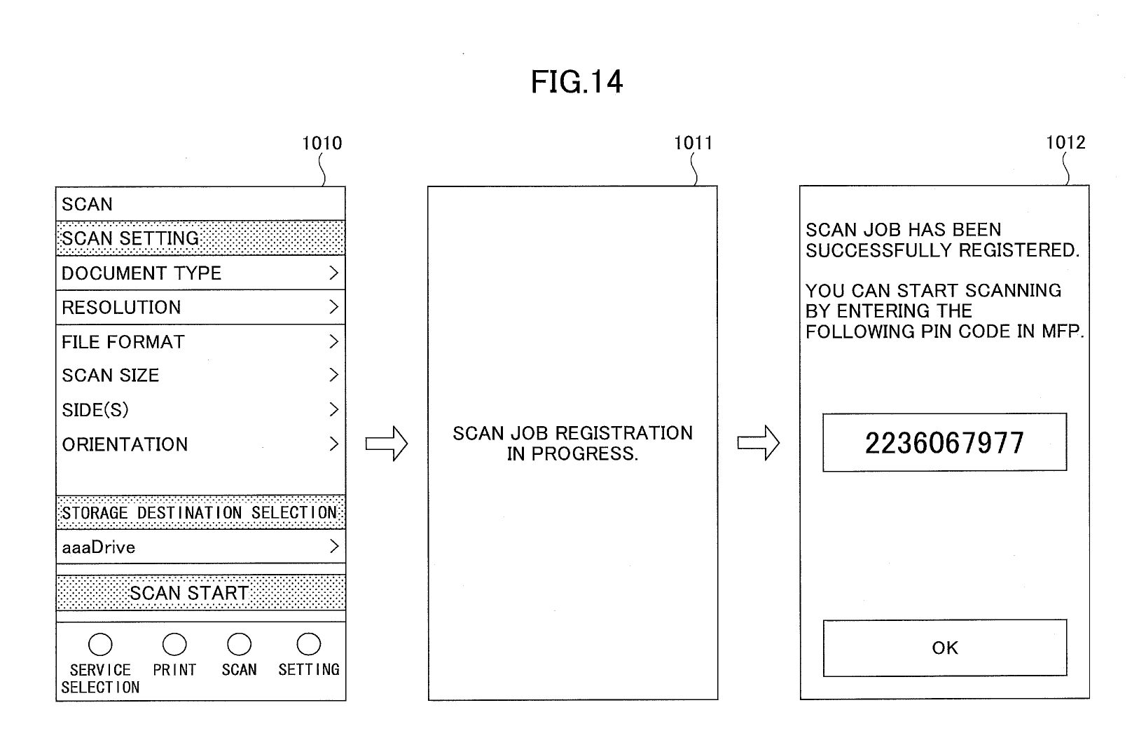

Then, in step S13, the user instructs the external application 31 to start a scan-to-external-storage process flow. For example, the user may instruct the external application 31 to start the scan-to-external-storage process flow via a scan job registration screen 1010 as illustrated in FIG. 14.

FIG. 14 illustrates an example screen transition of the external application 31 when a scan job is being registered. In the example of FIG. 14, the user may instruct the external application 31 to start the scan-to-external-storage process flow by setting up scan settings and selecting a storage destination via the scan job registration screen 1010 and pressing a “scan start” button on the scan job registration screen 1010.

Upon receiving the instruction to start the scan-to-external-storage process flow, the external application 31 displays a scan job registration progress screen 1011 as illustrated in FIG. 14. Note that in the example of FIG. 14, the scan-to-external-storage process flow is referred to as a “scan job registration” to enable the user to have a better understanding of the process flow being performed.

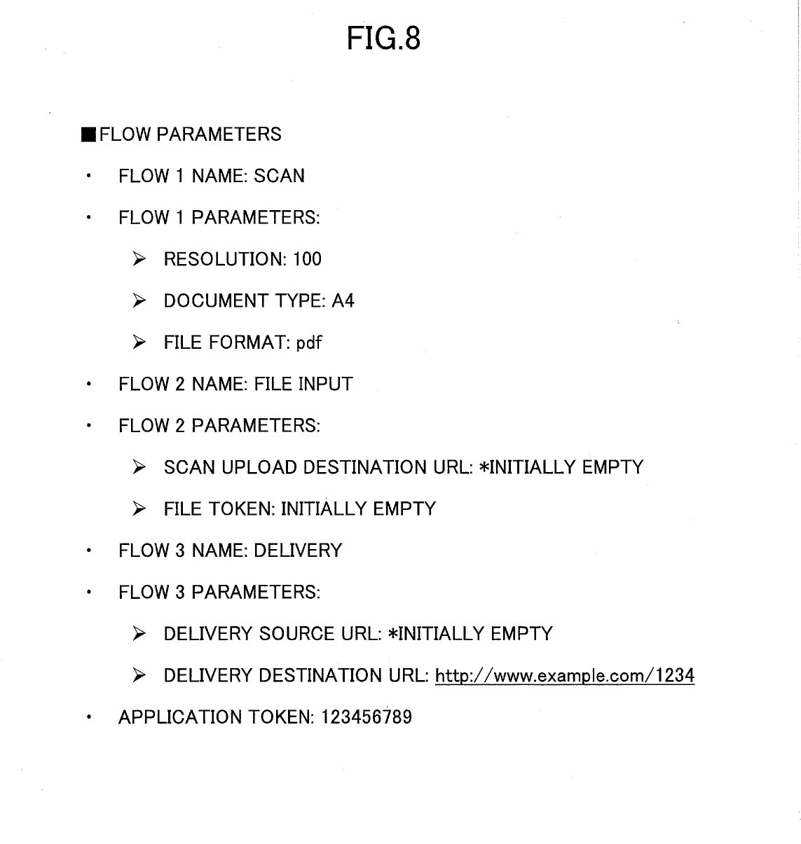

Then in step S14, the external application 31 sends a flow registration request to the flow control unit 113 specifying flow parameters as illustrated in FIG. 8, for example. FIG. 8 illustrates an example configuration of flow parameters included in the flow registration request. FIG. 8 includes the application token and flow parameters of “flow 1”, “flow 2”, and “flow 3”.

“Flow 1” includes flow parameters for a scan process. Thus, in FIG. 8, “flow 1 parameters” include “resolution”, “document type”, and “file format” as example parameters.

“Flow 2” includes flow parameters for file input. Thus, in FIG. 8, “flow 2 parameters” include “scan uploading destination URL” and “file token” as example parameters.

“Flow 3” includes flow parameter for a delivery process. Thus, in FIG. 8, “flow 3 parameters” include “delivery source URL” and “delivery destination URL” as example parameters. Note that in FIG. 8, information included as parameters are described in the format “<parameter name>:<value>”.

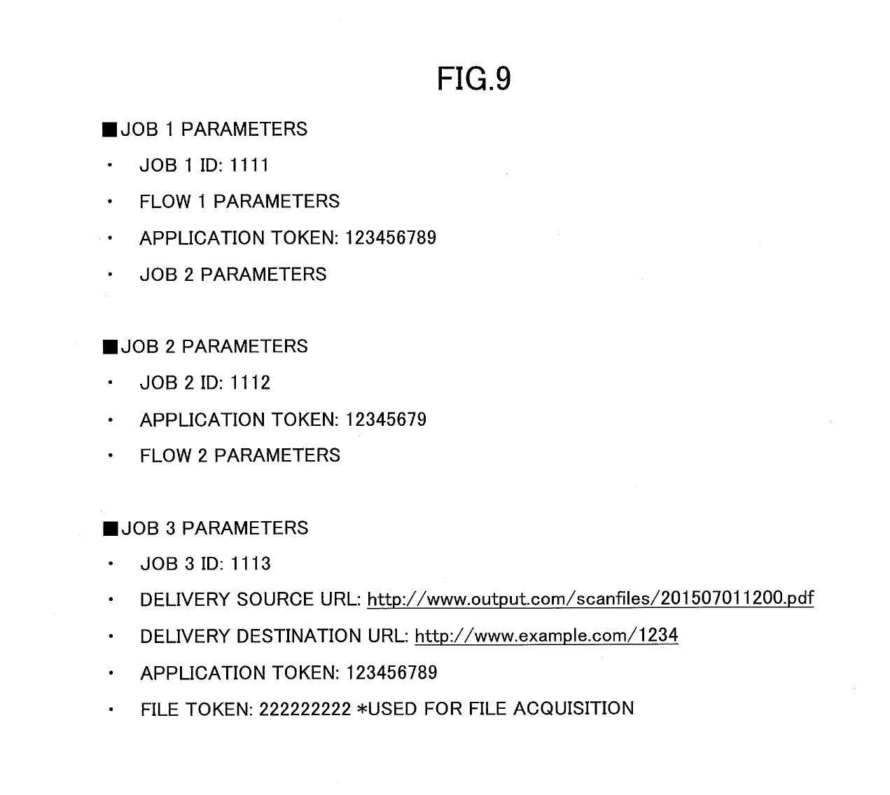

The flow control unit 113 of the service providing system 10 that receives the flow registration request including the flow parameters of FIG. 8 from the external application 31 creates jobs for each flow as illustrated in FIG. 9.

FIG. 9 illustrates an example configuration of job parameters. Note that “job 1 parameters” of FIG. 9 correspond to parameters created for “flow 1” of FIG. 8. Also, “job 2 parameters” of FIG. 9 correspond to parameters created for “flow 2” of FIG. 8, and “job 3 parameters” correspond to parameters created for “flow 3” of FIG. 8.

Then, in step S15, the flow control unit 113 executes a flow for the scan process based on the “job 1 parameters” of FIG. 9. Then in step S16, the flow control unit 113 specifies the “job 1 parameters” in a scan execution request that is sent to the scan component 123.

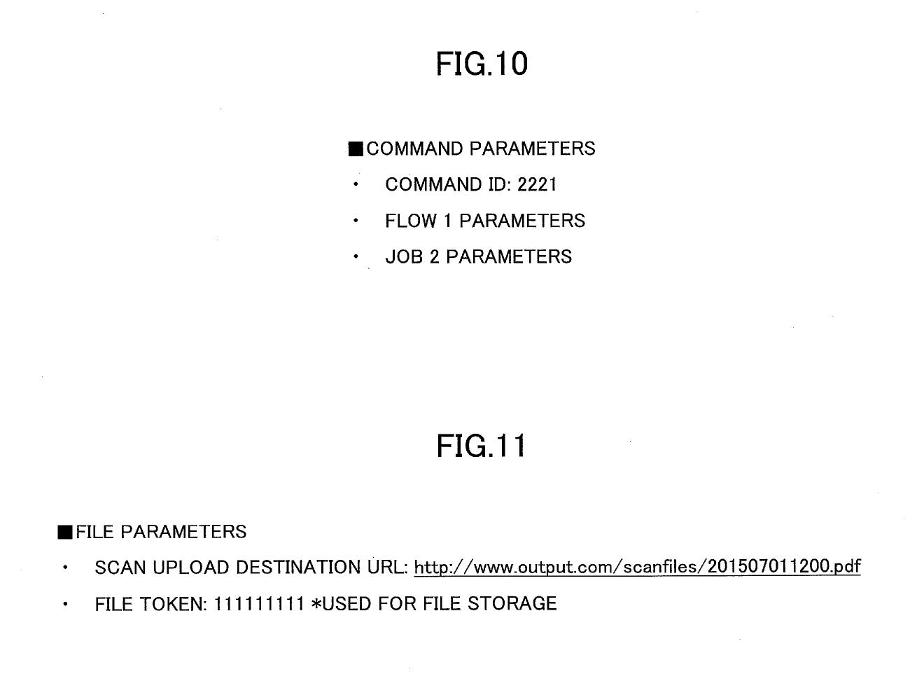

The scan component 123 that receives the scan execution request creates command parameters as illustrated in FIG. 10 based on the “job 1 parameters”. FIG. 10 illustrates an example configuration of the command parameters. The command parameters of FIG. 10 are created based on the “job 1 parameters” of FIG. 9.

Then, in step S17, the scan component 123 sends a command specifying the application token included in the command parameters of FIG. 10 and the “job 1 parameters” of FIG. 9 to the command delivery unit 115. Then, in step S18, the command delivery unit 115 uses the application token that is included as a parameter in the command received in step S117 to acquire a PIN code from the authentication management unit 104. Note that the PIN code is an example of code information for a scan setting.

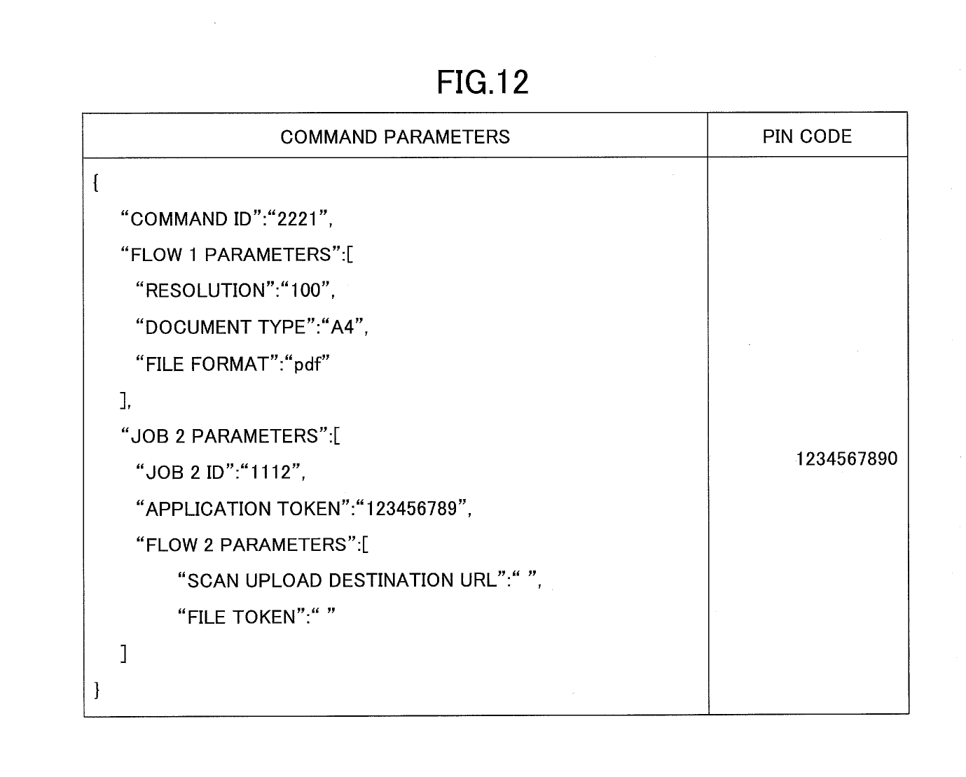

Then, in step S19, the command delivery unit 115 stores a table associating the command parameters with a PIN code as illustrated in FIG. 12. FIG. 12 illustrates an example table associating the command parameters with a PIN code. Note that the command parameters of FIG. 12 may be described in a predetermined format (e.g. JSON format), for example.

Then, in step S20, the command delivery unit 115 returns the PIN code associated with the command parameters of FIG. 10 to the scan component 123. In turn, the PIN code is returned to the external application 31 via the flow control unit 113. Upon receiving the PIN code, the external application 31 may display a scan job registration success screen 1012 as illustrated in FIG. 14, for example. The scan job registration success screen 1012 displays the PIN code that has been sent from the service providing system 10. Accordingly, the user operating the terminal apparatus 30 may be notified of the PIN code associated with the command parameters of FIG. 10.

Then, in step S21, the user starts the browser 51 of the image forming apparatus 20. In the present embodiment, it is assumed that the browser 51 has the URL of the application delivery unit 116 of the service providing system 10 set up as its default URL. When the browser 51 is started, the browser 51 acquires the device application information 132 from the application delivery unit 116 in step S22. The acquired device application information 132 is implemented and displayed on the browser 51 of the image forming apparatus 20.

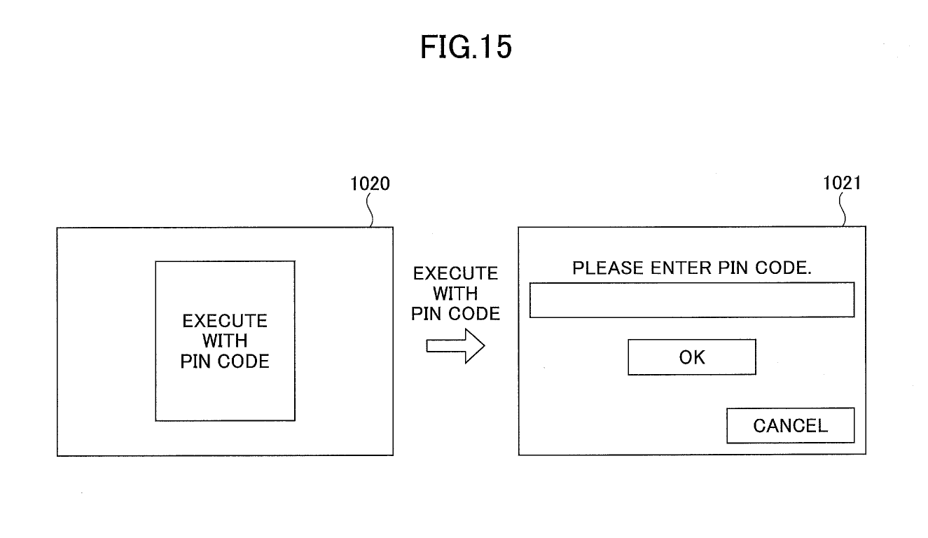

Then, in step S23, the browser 51 displays an initial screen 1020 as illustrated in FIG. 15. FIG. 15 illustrates an example screen transition of the browser 51 upon executing a scan job. The screens illustrated in FIG. 15 are displayed based on screen definitions included in the device application information 132. The initial screen 1020 of FIG. 15 includes an “execute with PIN code” button. When the “execute with PIN code” button is pressed by the user, the browser 51 displays a PIN code screen 1021 as illustrated in FIG. 15.

The PIN code screen 1021 includes a field for entering a PIN code. In step S24, the user enters the PIN code displayed on the scan job registration success screen 1012 of FIG. 14 in the PIN code screen 1021 and presses an “OK” button. Then, in step S25, the browser 51 starts execution of the scan job based on the PIN code.

Then, in step S26, the browser 51 sends a command acquisition request specifying the PIN code to the command delivery unit 115. In turn, in step S27, the command delivery unit 115 requests the authentication management unit 104 to perform verification of the PIN code. If the PIN code is successfully verified, the authentication management unit 104 returns authorization to the command delivery unit 115.

Upon receiving authorization from the authentication management unit 104, the command delivery unit 115 proceeds to step S28 where it acquires the command parameters associated with the PIN code from the table of FIG. 12 and returns the acquired command parameters to the browser 51. In step S29, the browser 51 determines the command type. Then, in step S30, the browser 51 specifies a command ID that is included in the command parameters in a command start request and sends the command start request to the command delivery unit 115.

Then, in step S31, the command delivery unit 115 acquires file parameters as illustrated in FIG. 11 from the data management unit 112. FIG. 11 illustrates an example configuration of file parameters. The file parameters illustrated in FIG. 11 include a scan upload destination URL and a file token. Then, in step S32, the command delivery unit 115 returns the file parameters to the browser 51.

Then, in step S33, the browser 51 executes a scan process based on the “flow 1 parameters” that are included in the command parameters of FIG. 12. Then, in step S34, the browser 51 sends a scan file storage request, including a scan file (image data) obtained as a result of executing the scan process and the file parameters of FIG. 11, to the data management unit 112. When the process of storing the scan file is completed, the data management unit 112 sends a completion notification to the browser 51.

Then, in step S35, the browser 51 sends a command completion notification specifying the command ID to the command delivery unit 115. Then, in step S36, the command delivery unit 115 sends a flow execution request specifying the “job 2 parameters” that are included in the command parameters of FIG. 10 to the flow control unit 113.

Note that in step S36, the command delivery unit 115 plugs in the values for the “scan upload destination URL” and the “file token” that are included in the file parameters of FIG. 11 as values for the “scan upload destination URL” and the “file token” of the “flow 2 parameters” of the “job 2 parameters”. Also, in step S37, the flow control unit 113 sends a file input execution request specifying the “job 2 parameters” to the file input component 121.

Then, in step S38, the file input component 121 sends a file acquisition request specifying the scan upload destination URL to the data management unit 112 and acquires the file token from the data management unit 112. The file input component 121 plugs in the acquired file token in the “flow 2 parameters” of the “job 2 parameters” and returns the “job 2 parameters” with the file token to the flow control unit 113. Then, in step S39, the flow control unit 113 plugs in the delivery source URL and the file token of the “job 3 parameters” and executes a delivery process flow based on the “job 3 parameters” of FIG. 9. Then, in step S40, the flow control unit 113 sends a delivery execution request specifying the “job 3 parameters” to the delivery component 122.

Then, in step S41, the delivery component 122 acquires the scan file from the delivery source URL using the file token of the “job 3 parameters” and stores the acquired scan file in the external storage system 40 corresponding to the delivery destination URL. Then, the delivery component 122 receives a completion notification from the external storage system 40 and sends the completion notification to the flow control unit 113.

Then, in step S43, the user operates a screen of the external application 31 to input an image acquisition instruction to acquire the scan file. In step S44, the external application 31 acquires the scan file from the external storage system 40 and displays the scan file (image data).

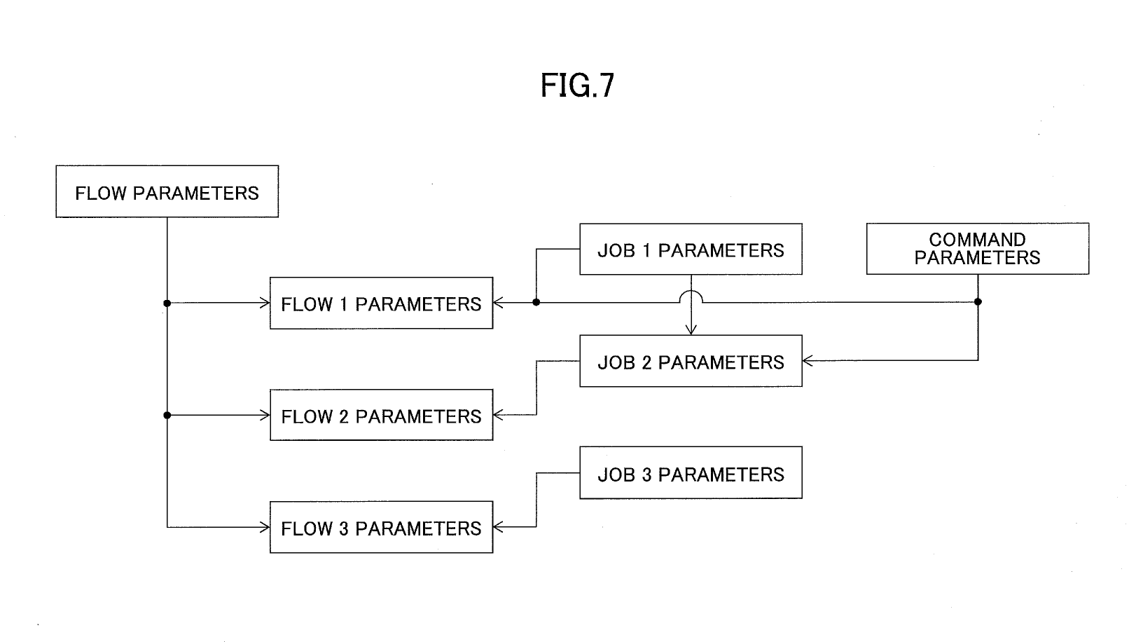

FIG. 7 illustrates the relationship between the flow parameters, the job parameters, and the command parameters used in the scan delivery process of FIGS. 5 and 6.

According to FIG. 7, “flow parameters” include “flow 1 parameters”, “flow 2 parameters”, and “flow 3 parameters”. Also, “job 1 parameters” include “flow 1 parameters” and “job 2 parameters”. Also, “job 2 parameters” includes “flow 2 parameters”. Also, “job 3 parameters” includes “flow 3 parameters”.

As can be appreciated, in the information processing system 1 according to the first embodiment, the service providing system 10 has the functions for executing a scan delivery process flow (e.g., flow registration, flow processing, PIN code generation/verification, and temporary file storage). Thus, even when there is a fault or a change in the specification of the scan delivery process flow, for example, an application of the image forming apparatus 20 does not have to be changed. In this way, development and maintenance of the application of the image forming apparatus 20 may be facilitated.

Also, in the information processing system 1 according to the first embodiment, the user may execute a scan process by simply entering a PIN code in the image forming apparatus 20, and thus, the user may be relieved of the burden of having to configure scan settings at the image forming apparatus 20. In this way, scan operations to be performed at the image forming apparatus 20 may be simplified.

### Second Embodiment

In the above-described first embodiment, a PIN code is used to execute a scan delivery process flow. In a second embodiment of the present invention, a scan delivery process flow is executed by logging in. Note that features of the second embodiment that are substantially identical to those of the first embodiment are given the same reference numerals and overlapping descriptions may be omitted.

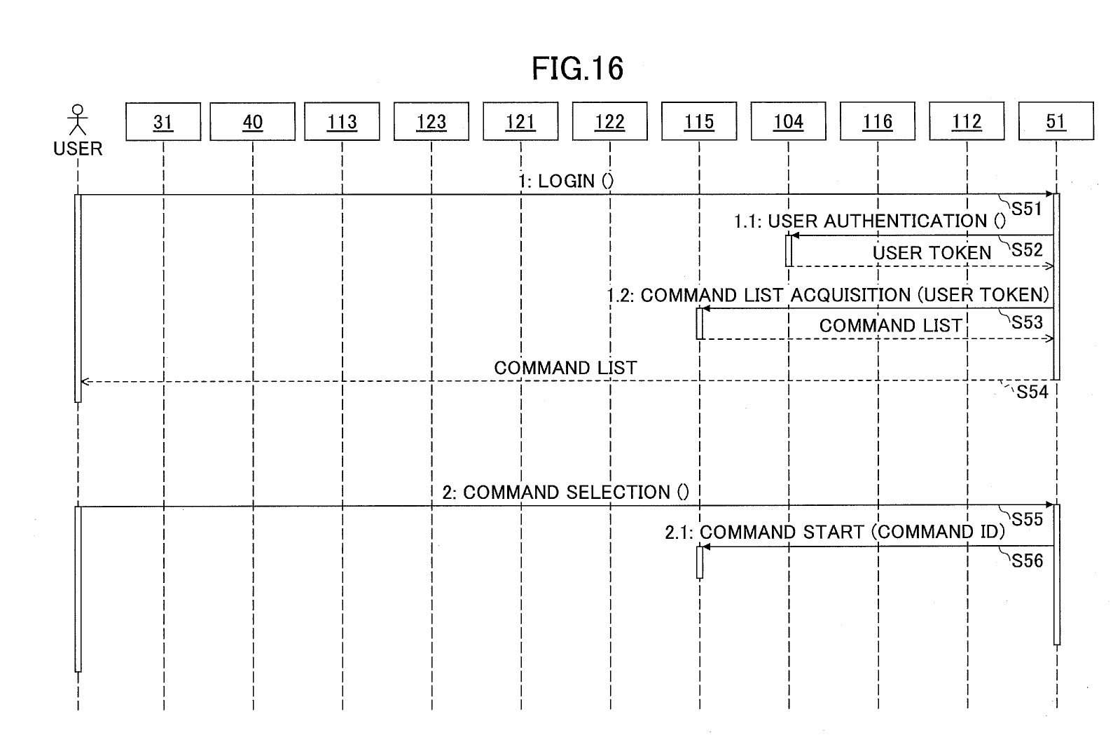

FIG. 16 is a sequence chart illustrating an example scan delivery process that is executed by logging in. Note that before proceeding to step S51 of FIG. 16, processes substantially identical to steps S11 to S23 of FIG. 5 are performed.

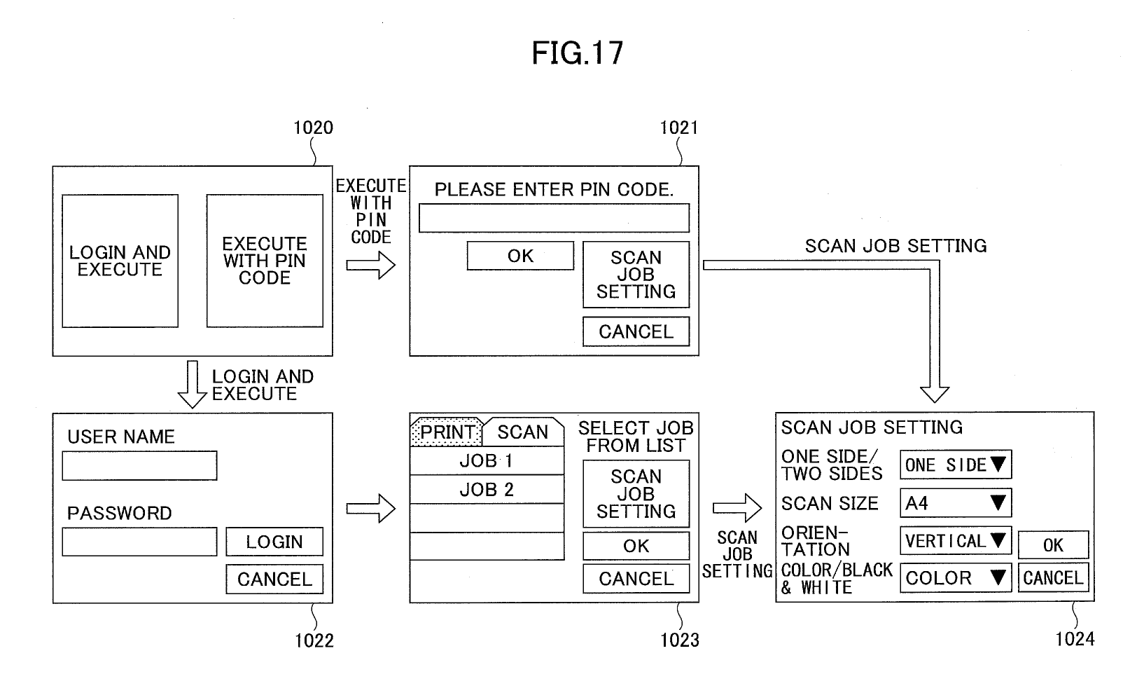

In the present embodiment, the browser 51 displays an initial screen 1020 as illustrated in FIG. 17. FIG. 17 illustrates example screen transitions of the browser 51 when a scan job is being executed according to the second embodiment. Note that the various screens illustrated in FIG. 17 are displayed based on screen definitions included in the device application information 132. The initial screen 1020 of FIG. 17 includes a “login and execute” button and a “execute with PIN code” button.

Note that when the “execute with PIN code” button is pressed by the user, the browser 51 displays a PIN code screen 1021 and the above-described process steps according to the first embodiment are performed. On the other hand, when the “login and execute” button is pressed by the user, the browser 51 displays a user authentication screen 1022. The user authentication screen 1022 includes fields for entering a user name and a password.

In step S51, the user enters a user name and a password in the user authentication screen 1022 and presses a login button. In step S52, the browser 51 requests the authentication management unit 104 of the service providing system 10 to authenticate the user name and password and acquires a user token from the authentication management unit 104. Then, in step S53, the browser 51 sends a command list acquisition request specifying the user token to the command delivery unit 115 and acquires a list of commands that have been registered by the user that has been successfully authenticated (login user) from the command delivery unit 115. The browser 51 then displays a command selection screen 1023 that includes the acquired list of commands.

Then, in step S55, the user selects a desired command from the list of commands displayed on the command selection screen 1023 and presses an OK button. Then, in step S56, the browser 51 specifies the command ID included in the command parameters of the command selected by the user in a command start request and sends the command start request to the command delivery unit 115. Note that processes after step S56 of FIG. 16 are substantially identical to the processes of step S30 and subsequent steps of FIG. 5, and as such, descriptions thereof are omitted.

Note that when a “scan job setting” button in the PIN code screen 1021 or the command selection screen 1023 of FIG. 17 is pressed, the browser 51 displays a scan job setting screen 1024. In this way, the user can change settings for a scan job from the scan job setting screen 1024.

The scan delivery process that is executed by the user logging in from the image forming apparatus 20 as illustrated in FIG. 16 may be convenient when the user forgets the PIN code that has been issued for a scan job, for example.

In the information processing system 1 according to the second embodiment, a scan process may be executed through user authentication instead of using a PIN code, for example. By performing user authentication at the image forming apparatus 20, the user may be relieved of the burden of having to configure scan settings at the image forming apparatus 20, and in this way, scan operations to be performed at the image forming apparatus 20 may be simplified.

### Third Embodiment

In the information processing system 1 according to a third embodiment of the present invention, a scan delivery process is performed using a service providing system API 301 that is included in the service providing system 10. Note that features of the third embodiment that are substantially identical to those of the first and second embodiments are given the same reference numerals and overlapping descriptions may be omitted.

<Software Configuration>

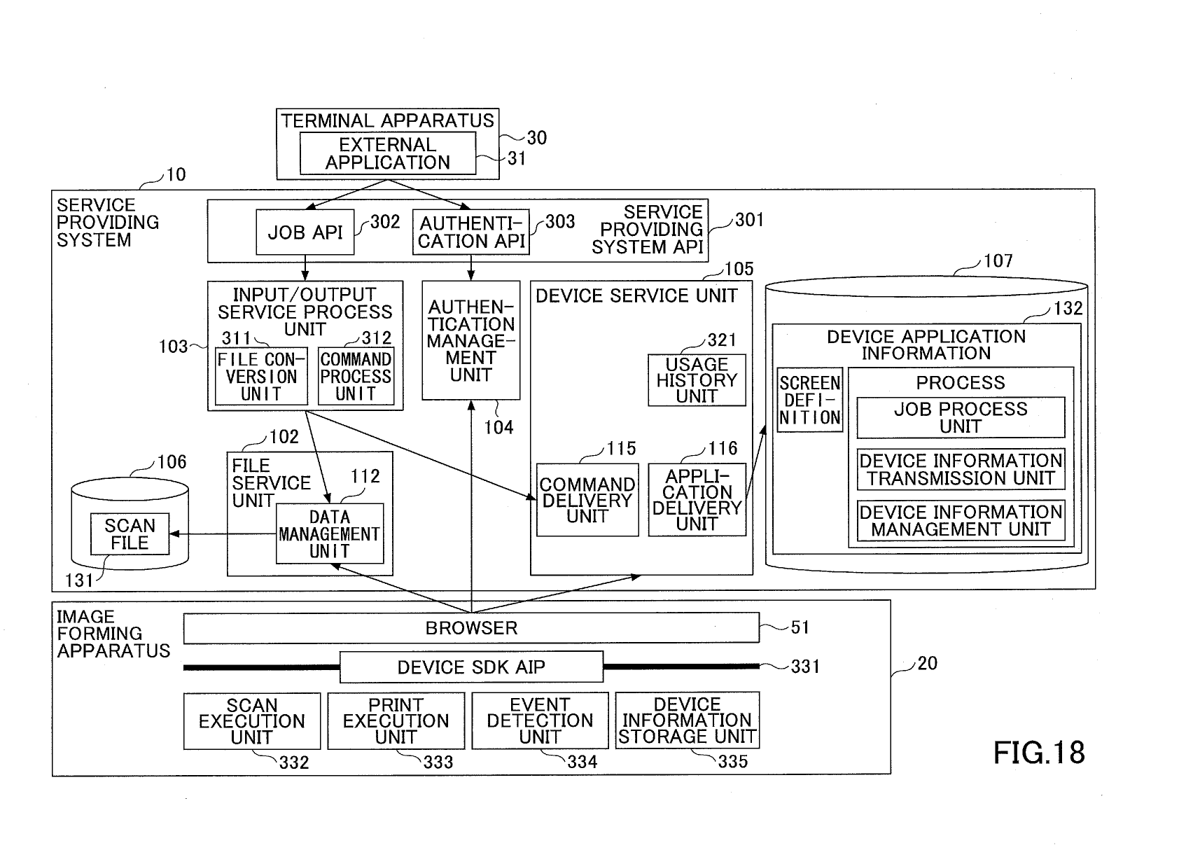

The information processing system 1 according to the third embodiment may have a functional configuration as illustrated in FIG. 18, for example. FIG. 18 is a block diagram illustrating an example functional configuration of the information processing system 1 according to the third embodiment.

The image forming apparatus 20 has the browser 51 installed therein. Also, the image forming apparatus 20 also includes a device SDK API 331. The browser 51 can use a scan execution unit 332, a print execution unit 333, an event detection unit 334, and a device information storage unit 335 via the device SDK API 331. Also, the browser 51 can acquire web content from the service providing system 10 and display the acquired web content.

The service providing system 10 is a system environment that provides a service, such as a cloud service', via the network N1. The service providing system 10 includes the file service unit 102, the input/output service process unit 103, the authentication management unit 104, the device service unit 105, the scan file storage unit 106, the device application information storage unit 107, and the service providing system API 301.

The service providing system API 301 includes a job API 302 and an authentication API 303. The external application 31 of the terminal apparatus 30 can use the input/output service process unit 103 via the job API 302. Also, the external application 31 can use the authentication management unit 104 via the authentication API 303.

In FIG. 18, the input/output service process unit 103 includes a file conversion unit 311 and a command process unit 312. The file conversion unit 311 performs processes relating to file conversion. The command process unit 312 performs processes relating to a command. Also, the device service unit 105 includes the command delivery unit 115, the application delivery unit 116, and a usage history unit 321. The usage history unit 321 performs processes relating to registration and acquisition of usage history information. Also, the device application information storage unit 107 stores the device application information 132. The device application information 132 includes screen definitions described in HTML or CSS, for example, and descriptions of processes for implementing a service. Note that processes described in the device application information 132 of FIG. 18 include a job process unit, a device information transmission unit, and a device information management unit.

The device application information 132 includes content, such as screen definitions described in HTML or CSS, for example, and process units described in a script language such as JavaScript (trademark), for example. The device application information 132 that has been downloaded may be implemented/displayed by the browser 51 on the image forming apparatus 20. In this way, the image forming apparatus 20 may download the device application information 132 stored in the service providing system 10 to implement a job process unit 341 on the browser 51 as described in detail below.

<Process Details>

In the following, processes implemented by the information processing system 1 according to the third embodiment are described.

<<Scan Delivery Service>>

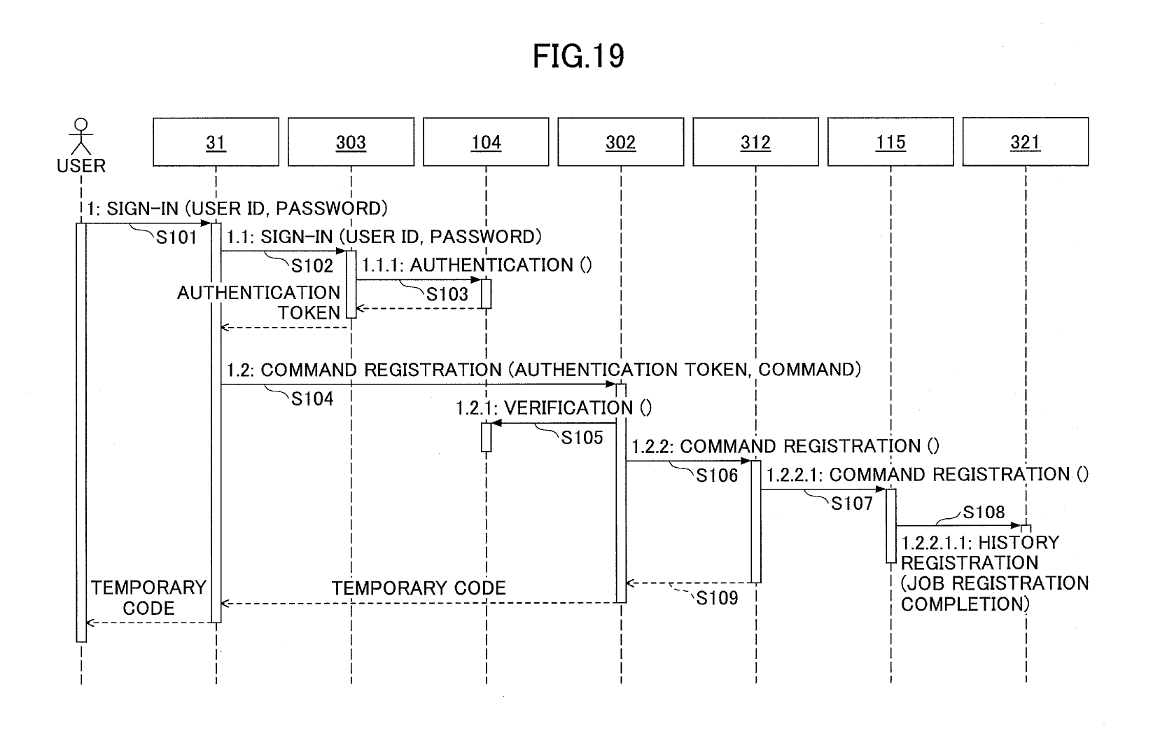

FIG. 19 is a sequence chart illustrating an example scan registration process that'is executed when the user signs in. In step S101, the user makes a sign-in request by specifying a user ID and a password on the external application 31 of the terminal apparatus 30.

Then, in step S102, the external application 31 sends a sign-in request to the authentication API 301 of the of the service providing system API 301 in the service providing system 10 specifying the user ID and the password. Then, in steps S103, the authentication API 303 sends an authentication request to the authentication management unit 104. If authentication is successful, the authentication management unit 104 issues an authentication token and returns the authentication token to the external application 31 via the authentication API 303.

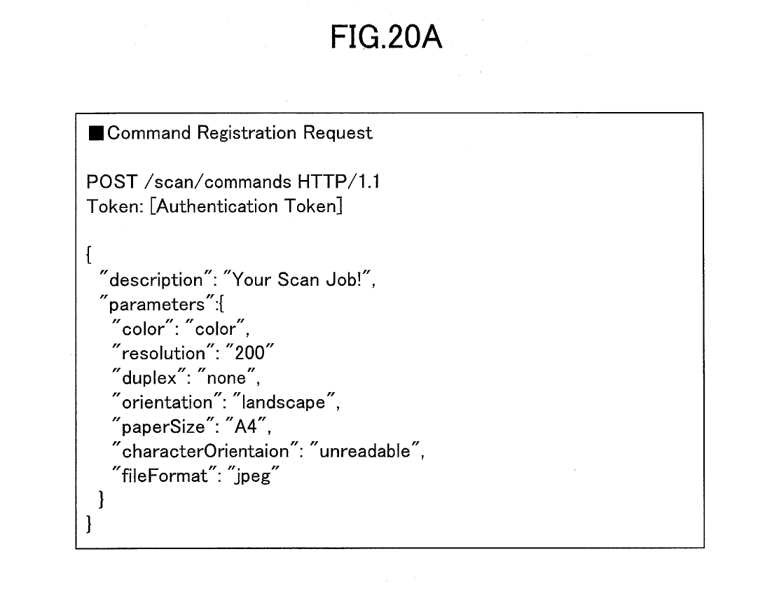

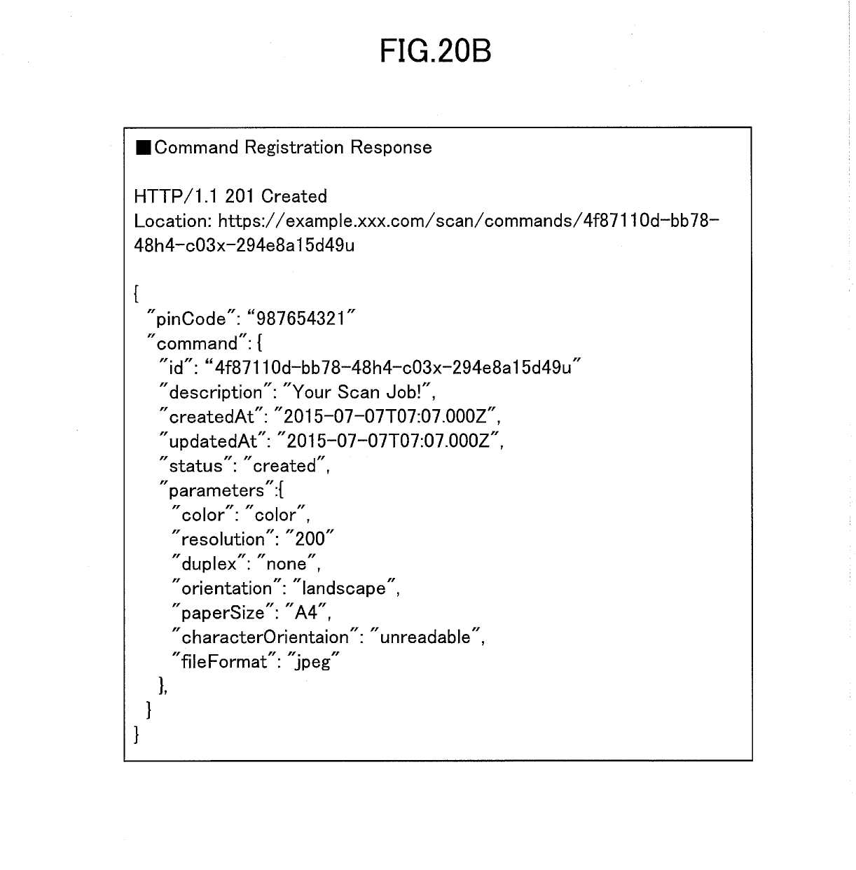

Then, in step S104, the external application 31 sends a command registration request specifying the authentication token and a command as illustrated in FIG. 20A, for example, to the job API 302 of the service providing system API 301 in the service providing system 10. FIGS. 20A and 20B respectively illustrate examples of a command registration request and a command registration response.

In step S105, the job API 302 specifies the authentication token in a verification request that is sent to the authentication management unit 104. In turn, the authentication management unit 104 verifies the authentication token that is specified in the verification request, and if the authentication token is successfully verified, returns a temporary code to the job API 302.

If the authentication token is successfully verified, in step S106, the job API 302 specifies the temporary code in a command registration request that is sent to the command process unit 312 of the input/output service process unit 103. Then, in step S107, the command process unit 312 sends the command registration request specifying the temporary code to the command delivery unit 115. In turn, the command delivery unit 115 stores the command in association with the temporary code. Then, in step S108, the command delivery unit 115 sends a history registration request to the usage history unit 321 to register usage history information indicating that command registration has been completed. In turn, the usage history unit 321 registers the usage history information indicating the completion of the command registration.

Then, in step S109, the command process unit 312 returns a command registration response, such as that illustrated in FIG. 20B, including the temporary code stored in association with the command, to the job API 302. In turn, the job API 302 sends the command registration response as illustrated in FIG. 20B to the external application 31.

When the external application 31 receives the command registration response as illustrated in FIG. 20B from the job API 302, the external application 31 displays the temporary code included therein. Accordingly, the user operating the terminal apparatus 30 may be notified of the temporary code associated with the registered command. Note that in FIG. 19, an example in which the user operates the external application 31 is illustrated. However, embodiments of the present invention are not limited thereto and a PC or some other system may be operated, for example.

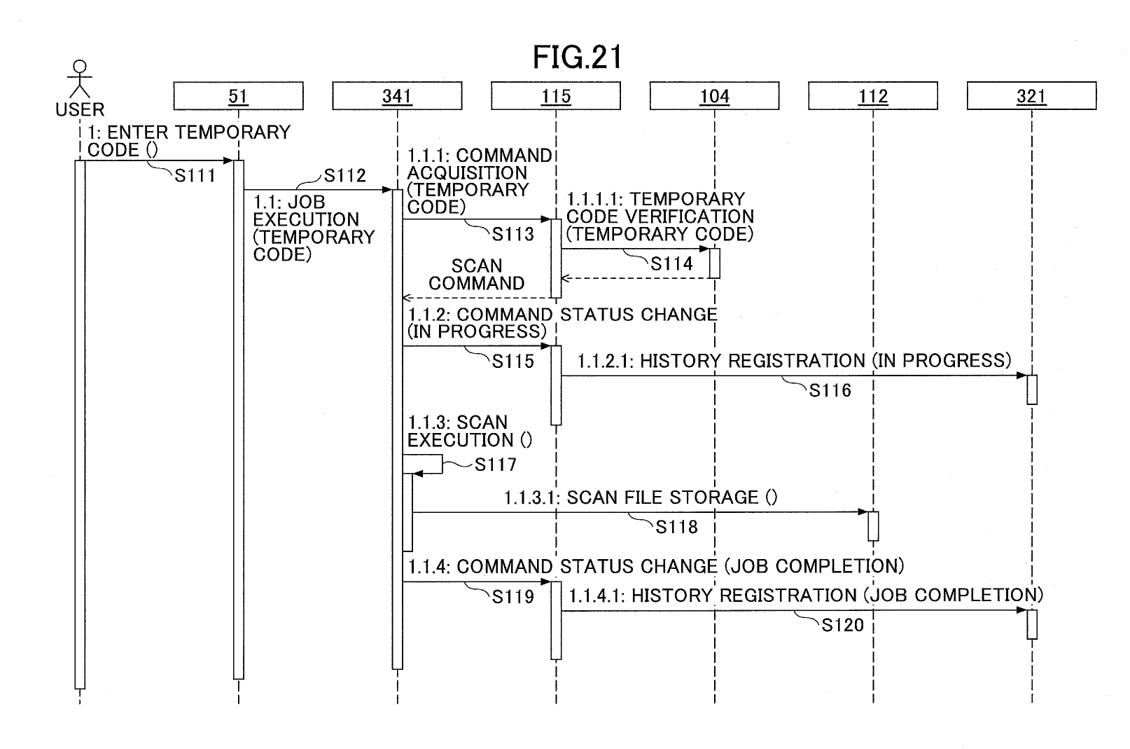

FIG. 21 is a sequence chart illustrating an example scan execution process. In step S111, the user enters a temporary code in the browser 51 to direct the image forming apparatus 20 to execute a scan job based on the temporary code.

Then, in step S112, the browser 51 sends a job execution request to the job process unit 341 that is run on the browser 51 of the image forming apparatus 20 to execute the scan job based on the temporary code. Then, in step S113, the job process unit 341 sends a command acquisition request specifying the temporary code to the command delivery unit 115. Then, in step S114, the command delivery unit 115 requests the authentication management unit 104 to verify the temporary code. If the temporary code is successfully verified, the authentication management unit 104 returns an authorization to the command delivery unit 115.

The command delivery unit 115 that receives the authorization from the authentication management unit 104 returns a command (scan job) that is associated with the temporary code to the job process unit 341. Then, in step S115, the job process unit 341 sends a command status change request to the command delivery unit 115 specifying that execution of the scan job is in progress. Then, in step S116, the command delivery unit 115 requests the usage history unit 321 to register usage history information indicating that execution of the scan job is in progress. In turn, the usage history unit 321 changes the usage history information relating to the status of the scan job from job registration completion to job execution in progress.

Then, in step S117, the job process unit 341 controls the scan execution unit 332 to execute the scan job. Then, in step S118, the job process unit 341 sends a scan file storage request to the data management unit 112 to store a scan file obtained by executing the scan job. Then, in step S119, the job process unit 341 sends a command status change request to the command delivery unit 115 to change information indicating the command status of the scan job to job completion. Then, in step S120, the command delivery unit 115 requests the usage history unit 321 to register usage history information indicating job completion of the scan job. In turn, the usage history unit 321 changes the usage history information relating to the status of the scan job from job execution in progress to job completion.

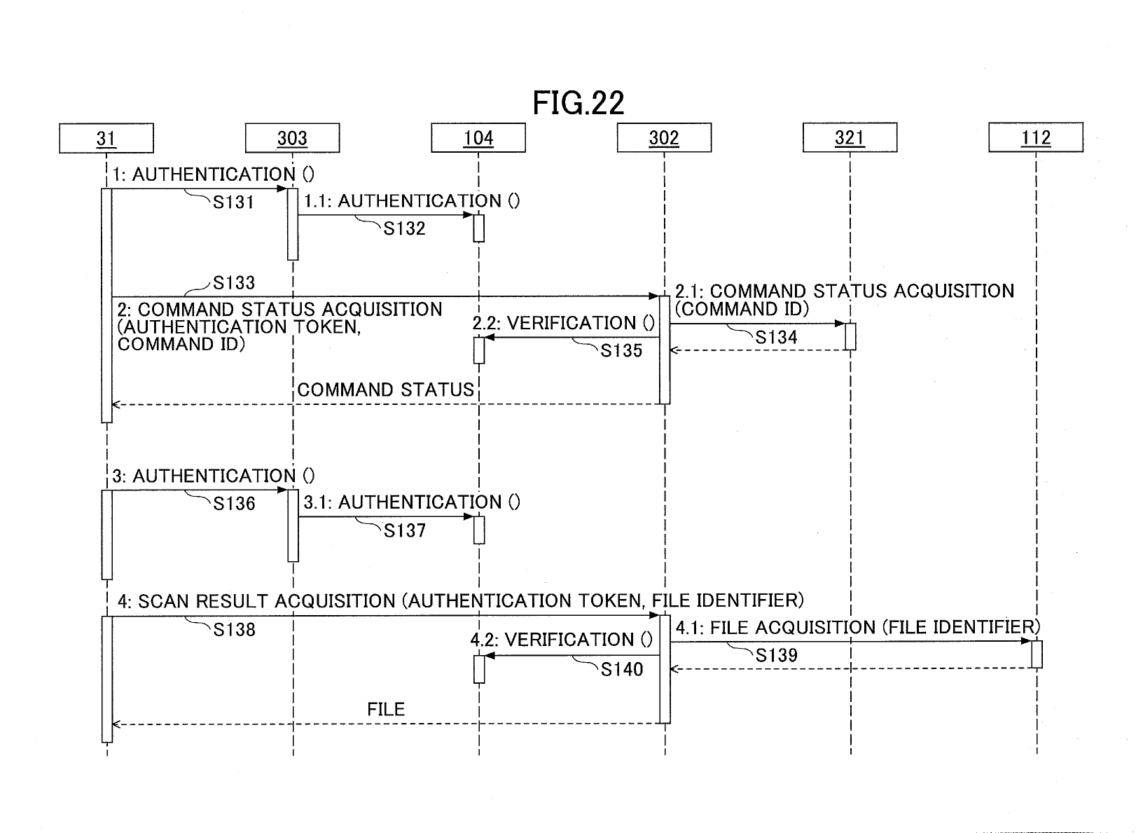

FIG. 22 is a sequence chart illustrating an example command status/command execution result acquisition process. In step S131, the external application 31 sends an authentication request to the authentication API 303 of the service providing system API 301 in the service providing system 10. Then, in step S132, the authentication API 303 sends the authentication request to the authentication management unit 104. If authentication is successful, the authentication management unit 104 issues an authentication token and returns the authentication token to the external application 31 via the authentication API 303.

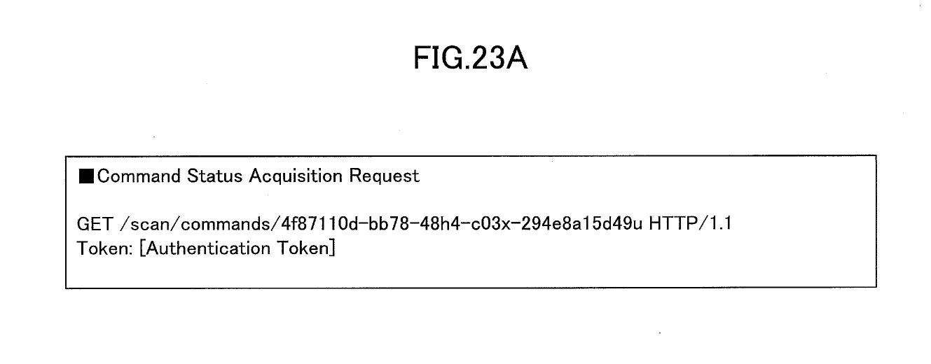

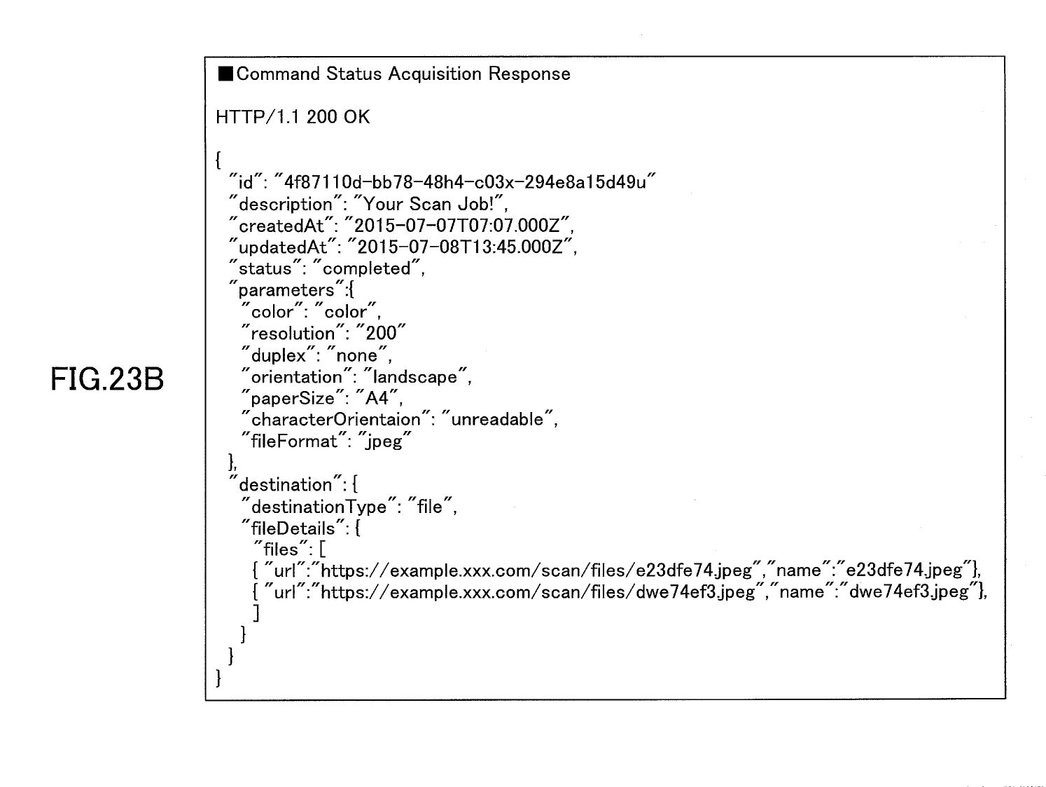

Then, in step S133, the external application 31 sends a command status acquisition request to the job API 302 specifying the authentication token and a command ID as illustrated in FIG. 23A, for example. FIGS. 23A and 23B respectively illustrate examples of a command status acquisition request and a command status acquisition response.

Then, in step S134, the job API 302 sends a command status acquisition request specifying the command ID to the usage history unit 321 and acquires command status information of the command identified by the command ID from the usage history unit 321. Then, in step S135, the job API 302 requests the authentication management unit 104 to verify the authentication token. In turn, the authentication management unit 104 verifies the authentication token and returns the verification result to the job API 302. If the authentication token is successfully verified, the job API 302 returns a command status acquisition response, such as that illustrated in FIG. 23B, including the command status information acquired from the usage history unit 321, to the external application 31.

Note that the processes of step S136 and subsequent steps represent example processes for acquiring a scan file obtained by executing a scan job as an example of a command execution result. In step S136, the external application 31 sends an authentication request to the authentication API 303 of the service providing system API 301 in the service providing system 10. Then, in step S137, the authentication API 303 sends the authentication request to the authentication management unit 104.

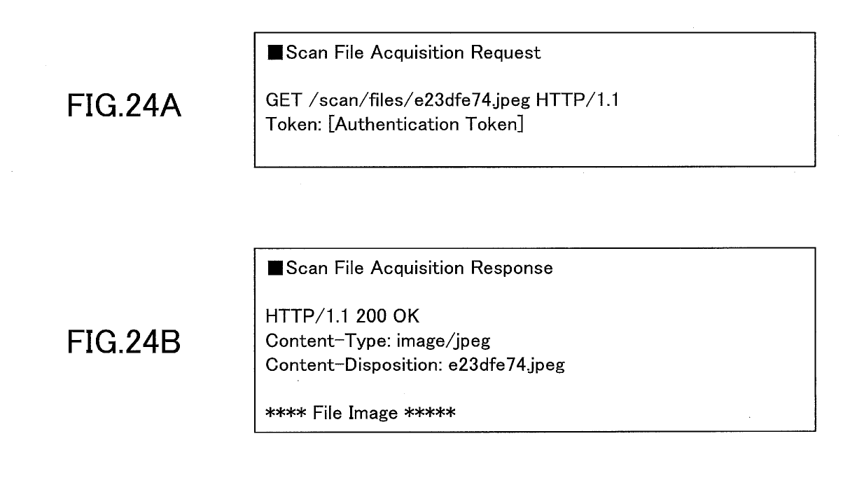

If the authentication is successful, the authentication management unit 104 issues an authentication token and returns the authentication token to the external application 31 via the authentication API 303. Then, in step S138, the external application 31 sends a scan result acquisition request, such as that illustrated in FIG. 24A, specifying the authentication token and a file identifier, to the job API 302. FIGS. 24A and 24B respectively illustrate examples of a scan file acquisition request and a scan file acquisition response.

Then, in step S139, the job API 302 sends a file acquisition request specifying the file identifier to the data management unit 112 and acquires a corresponding scan file from the data management unit 112. Then, in step S140, the job API 302 requests the authentication management unit 104 to verify the authentication token. In turn, the authentication management unit 104 verifies the authentication token and returns the verification result to the job API 302. If the authentication token is successfully verified, the job API 302 returns a scan file acquisition response, such as that illustrated in FIG. 24B, including the file acquired from the data management unit 112, to the external application 31.

As described above, in the information processing system 1 according to the third embodiment, the service providing system API 301 for operating the image forming apparatus 20 is provided in the service providing system 10. The service providing system 10 can cooperate with the external storage system 40 and also store content to be displayed on the operation panel 22 of the image forming apparatus 20.

Thus, the information processing system 1 according to the third embodiment may enhance flexibility in cooperating with the external storage system 40 and improve application development efficiency of the external application 31 that uses the image forming apparatus 20. Note that the service providing system API 301 may include APIs for implementing various processes, such as command registration, command status acquisition, scan file uploading, and scan file downloading, for example.

Note that in the information processing system 1 according to the third embodiment, the applications installed in the image forming apparatus 20 are not subject to application development. Thus, the external application 31 that uses the image forming apparatus 20 can be developed without taking into account the internal specifications and behavior of the image forming apparatus 20. Also, by simplifying the service providing system API 301 such that it may be operated using HTML and JavaScript, for example, the information processing system 1 according to the third embodiment may facilitate development of a web application for operating the image forming apparatus 20.

### Fourth Embodiment

According to a fourth embodiment of the present invention, an electronic file (scan file) that is generated by scanning a document using the scan delivery service as described above in connection with the first through third embodiments is automatically classified and stored in a corresponding external storage system. Note that features of the fourth embodiment that are substantially identical to those of the first through third embodiments are given the same reference numerals and overlapping descriptions may be omitted.

<System Configuration>

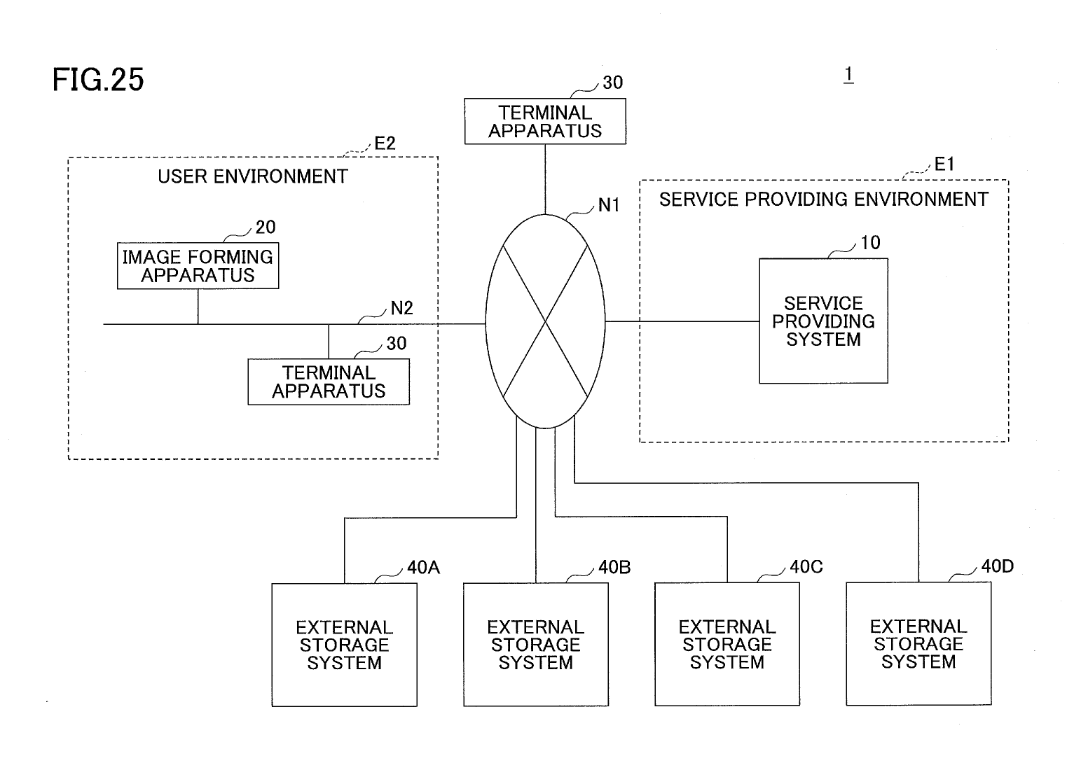

FIG. 25 is a block diagram illustrating an example configuration of the information processing system 1 according to the fourth embodiment. In FIG. 25, the information processing system 1 includes four external storage systems 40A-40D instead of a single external storage system 40 of the information processing system 1 illustrated in FIG. 1. Note that in the following descriptions, the external storage systems 40A-40D may generically be referred to as “external storage system 40” when they do not need to be distinguished from one another.

<Software Configuration>

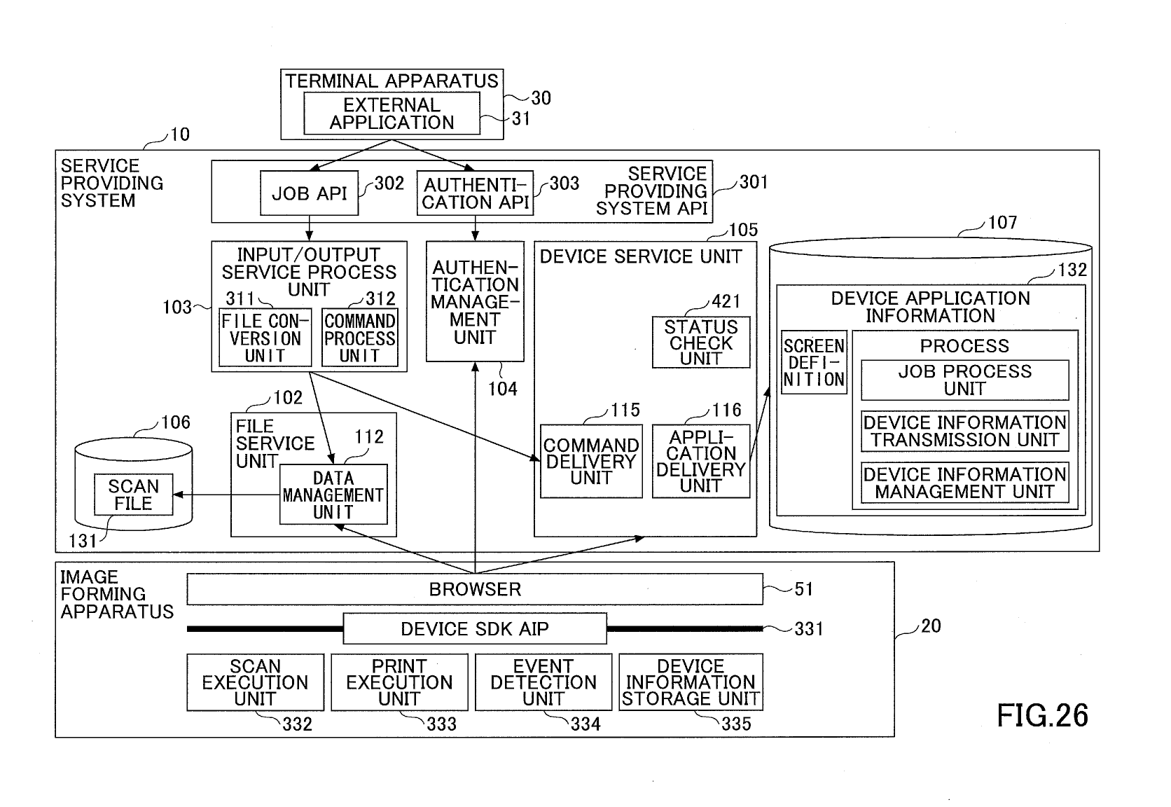

The information processing system 1 according to the fourth embodiment may have a functional configuration as illustrated in FIG. 26, for example. FIG. 26 is a block diagram illustrating an example functional configuration of the information processing system 1 according to the fourth embodiment. The information processing system 1 illustrated in FIG. 26 includes a status check unit 421 in addition to the functional elements of the information processing system 1 according to the third embodiment as illustrated in FIG. 18. The status check unit 421 sends a status check request to the image forming apparatus 20 to inquire whether the image forming apparatus 20 is capable of performing a scanning operation.

<Process Details>

In the following, processes performed by the information processing system 1 according to the fourth embodiment are described.

<<Scan Job Registration and Execution>>

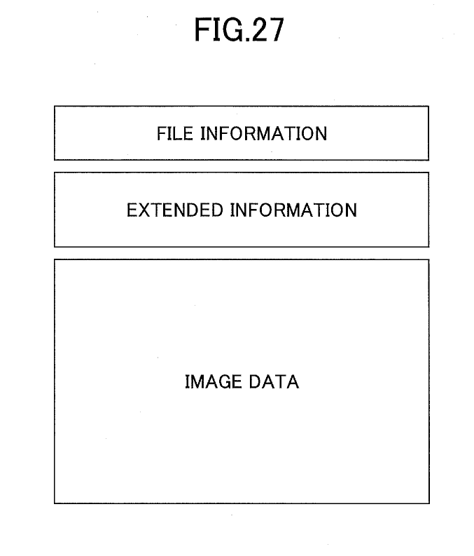

The information processing system 1 according to the fourth embodiment performs a registration process substantially identical to the registration process illustrated in FIG. 19 to register a scan job (command). Also, the information processing system 1 according to the fourth embodiment performs an execution process similar to the execution process illustrated in FIG. 21 to execute a scan job. Note, however, that according to the fourth embodiment, in the scan file storage process of step S118 of FIG. 21, for example, a scan file having a configuration as illustrated in FIG. 27 is stored in the scan file storage unit 106.

FIG. 27 illustrates an example configuration of a scan file. The scan file illustrated in FIG. 27 includes file information, extended information, and image data. The file information is information relating to the scan file including a file name. The extended information is information relating to the image data that is extracted by the service providing system 10 or the image forming apparatus 20. The image data is the actual data representing the image obtained by scanning a document. The extended information is information representing features of the image data, such as information extracted by performing an OCR (optical character recognition) process or some other image process on the image data, for example.

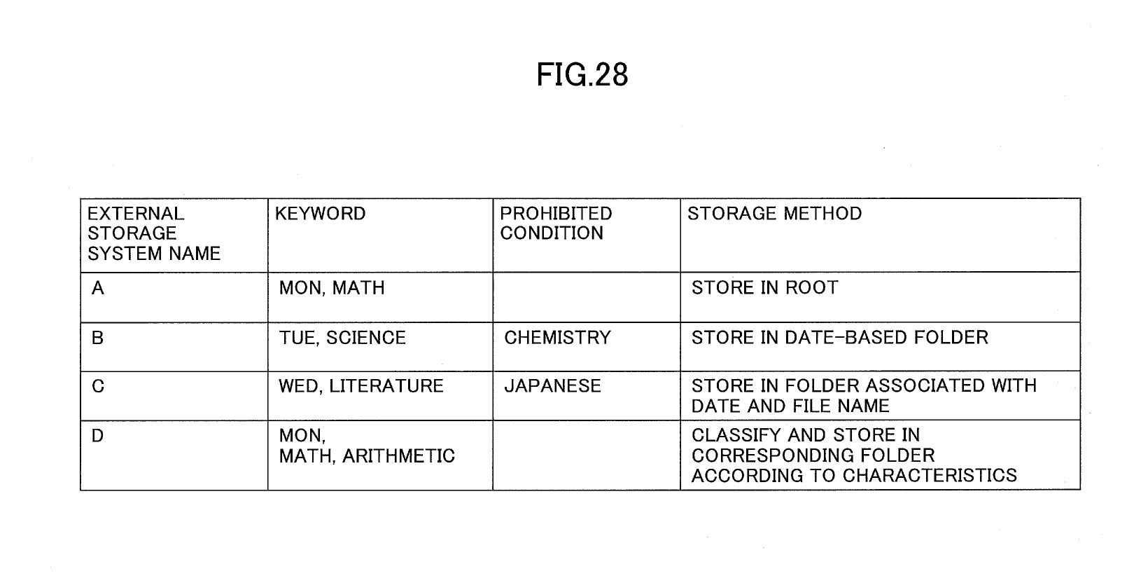

In the present embodiment, the external application 31 of the terminal apparatus 30 receives a scan file having the configuration as illustrated in FIG. 27 from the service providing system 10. The external application 31 determines a storage destination of the received scan file based on classification information as illustrated in FIG. 28, for example. FIG. 28 is a table illustrating an example of classification information used by the external application 31 to determine a storage destination and a storage method for a scan file.

The classification information of FIG. 28 includes information items, such as “external storage system name”, “keyword”, “prohibited condition”, and “storage method”. The classification information of FIG. 28 associates keywords, prohibited conditions, and storage methods with the external storage systems 40A-40D.

For example, if a scan file to be stored having the configuration as illustrated in FIG. 27 includes a keyword that is listed under the item “keyword” of the classification information of FIG. 28 in its file information and/or extended information, the external application 31 selects a corresponding record of the classification information that includes the keyword. However, if the scan file to be stored includes a condition listed under the item “prohibited condition” of the classification information of FIG. 28 in its file information and/or extended information, the external application 31 does not select the corresponding record of the classification information even if it includes the keyword.

More specifically, for example, if the file information and/or the extended information of the scan file to be stored includes the keywords “MON, MATH”, the external storage system 40A with the external storage system name “A” is selected as the storage destination of the scan file. Also, if the file information and/or the extended information of the scan file to be stored includes the keywords “MON, MATH”, “STORE IN ROOT” is selected as the storage method to be used to store the scan file.

Also, if the file information and/or the extended information of the scan file to be stored includes the prohibited condition “CHEMISTRY”, the external storage system 40B will not be selected as the storage destination of the scan file even if the file information and/or the extended information of the scan file includes the keywords “TUE, SCIENCE”.

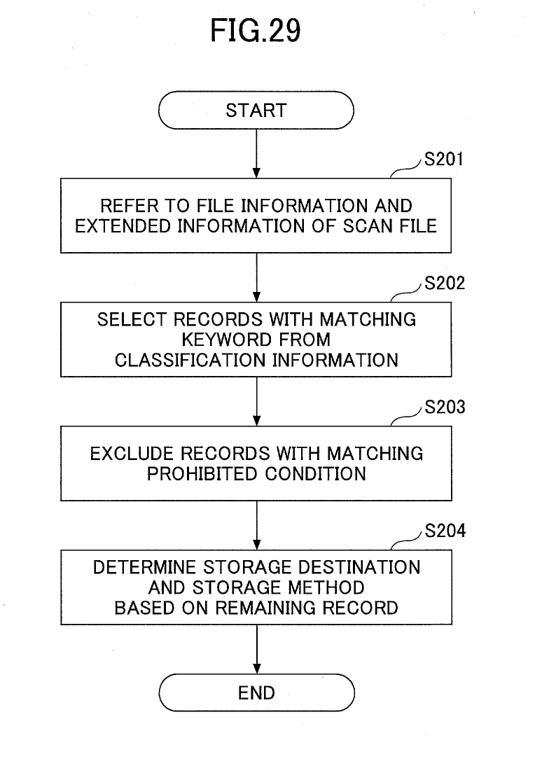

For example, the external application 31 may determine a storage destination of a scan file and a storage method for storing the scan file in the manner illustrated in FIG. 29. FIG. 29 is a flowchart illustrating an example process for determining the storage destination and the storage method for a scan file.

In step S201, the external application 31 refers to the file information and the extended information of a scan file having the configuration as illustrated in FIG. 27. Then, in step S202, based on the file information and the extended information of the scan file, the external application 31 selects one or more records of the classification information including keywords matching those included in the scan file.

Also, in step S203, the external application 31 excludes one or more records including prohibited conditions matching those included in the scan file from among the records selected in step S202. Then, in step S204, the external application 31 determines the storage destination and the storage method for the scan file based on a remaining record that has not been excluded in step S203.

Note that FIG. 27 illustrates an example scan file that includes information extracted by the service providing system 10 by performing an image process such as an OCR process on image data as the extended information. However, in other examples, the image process such as an OCR process may be performed by the terminal apparatus 30. In this case, the scan file may only include the file information and the image data.

Based on the scan file including the file information and the image data, the external application 31 of the terminal apparatus 30 may extract the extended information by performing an image process such as an OCR process on the image data. After extracting the extended information, the external application 31 may perform process operations similar to those of the above-described example in which the extended information is extracted by the service providing system 10.

Further, in the above-described example, the external application 31 determines the storage destination and the storage method for the scan file. However, in other examples, the classification information as illustrated in FIG. 28 may be provided in the service providing system 10 and the storage destination and the storage method for the scan file may be determined by the service providing system 10. In this case, the service providing system 10 may use the extended information of the scan file of FIG. 27 to determine the storage destination and the storage method for the scan file and notify the external application 31 of the determined storage destination and storage method, for example.

According to an aspect of the fourth embodiment of the present invention, a scan file is classified based on file information and extended information of an electronic file (image data) that is generated by scanning a document, and a storage destination and a storage method for the scan file may be automatically selected based on the classification result.

Although the present invention has been described above with reference to certain illustrative embodiments, the present invention is not limited to these embodiments, and numerous variations and modifications may be made without departing from the scope of the present invention.

What is claimed is:

1. A scan processing system for controlling an input/output device including a scanner to execute a scan process, the scan processing system comprising:
a memory storing a program; and
a processor configured to execute the program to implement processes of
accepting, from a terminal apparatus, a registration of a scan setting for the scan process to be executed by the input/output device;
issuing code information for the scan setting and sending the issued code information to the terminal apparatus in response to the registration of the scan setting;
storing the scan setting that has been accepted from the terminal apparatus in association with the code information that has been sent to the terminal apparatus in response to the registration; and
upon receiving the code information from the input/output device, sending the scan setting that is stored in association with the code information to the input/output device and controlling the input/output device to execute the scan process based on the scan setting.

2. The scan processing system according to claim 1, wherein the processor further implements processes of
accepting, from the terminal apparatus, a flow registration request for registering a flow including a series of processes for controlling the input/output device to execute the scan process; and
executing the series of processes based on flow settings for the series of processes that are included in the flow registration request.

3. The scan processing system according to claim 2, wherein the processor further implements processes of
accepting, from the terminal apparatus, flow parameters of the flow including the scan setting of the scan process to be executed by the input/output device;
acquiring image data that is obtained as a result of the input/output device executing the scan process; and
storing the acquired image data in a storage destination that is accessible by the terminal apparatus.

4. The scan processing system according to claim 1, wherein the processor further implements processes of
authenticating a user;
sending a series of the scan settings that are stored in association with the user that has been authenticated to the input/output device;
sending the scan setting that has been selected by the user to the input/output device; and
controlling the input/output device to execute the scan process based on the selected scan setting.

5. An information processing system comprising:
an input/output device including a scanner; and
a scan processing system configured to control the input/output device to execute a scan process;
wherein the scan processing system includes
a memory storing a program; and
a processor configured to execute the program to implement processes of
accepting, from a terminal apparatus, a registration of a scan setting for the scan process to be executed by the input/output device;
issuing code information for the scan setting and sending the issued code information to the terminal apparatus in response to the registration of the scan setting;
storing the scan setting that has been accepted from the terminal apparatus in association with the code information that has been sent to the terminal apparatus in response to the registration; and
upon receiving the code information from the input/output device, sending the scan setting that is stored in association with the code information to the input/output device and controlling the input/output device to execute the scan process based on the scan setting.

6. A cooperative processing method that is implemented by a scan processing system for controlling an input/output device including scanner to execute a scan process, the cooperative processing method comprising steps of:
accepting, from a terminal apparatus, a registration of a scan setting for the scan process to be executed by the input/output device;
issuing code information for the scan setting and sending the issued code information to the terminal apparatus in response to the registration of the scan setting;
storing the scan setting that has been accepted from the terminal apparatus in association with the code information that has been sent to the terminal apparatus in response to the registration; and
upon receiving the code information from the input/output device, sending the scan setting that is stored in association with the code information to the input/output device and controlling the input/output device to execute the scan process based on the scan setting.
